(19) United States
(12) Patent Application Publication
(10) Pub. No.: US 2025/0077929 A1
(43) Pub. Date: Mar. 6, 2025

(54) SYSTEM AND METHOD FOR PERFORMING MACHINE LEARNING USING A QUANTUM COMPUTER

(71) Applicant: Quantinuum Ltd., London (GB)

(72) Inventors: Matthias Rosenkranz, Cambridge (GB); Luuk Coopmans, Oxford (GB); Marcello Benedetti, Kaunas (LT)

(73) Assignee: Quantinuum Ltd., London (GB)

(21) Appl. No.: 18/749,863

(22) Filed: Jun. 21, 2024

(30) Foreign Application Priority Data
Jun. 23, 2023 (GB) 2309523.5

(51) Int. Cl. G06N 10/60; G06N 10/40

(52) U.S. Cl. CPC G06N 10/60; G06N 10/40

(57) ABSTRACT

A system and method perform machine learning using a quantum computer. A model comprises a Quantum Boltzmann machine with a Hamiltonian ansatz having a set of operators and a set of parameters. A first stage of training the model against data from a target is performed on classical computing hardware, using a selected subset of the set of operators, to obtain optimized values for a subset of the set of parameters and a partly trained model. A second stage of training the model against data from the target is performed, at least partly using quantum computer hardware, using a larger subset of the set of operators to obtain optimized values for a larger subset of the set parameters for the model. The optimized parameter values from the first stage of training are used to initialize the corresponding parameters for the second stage of training.

### CROSS-REFERENCE TO RELATED APPLICATION

This application claims priority under 35 U.S.C. § 119 to United Kingdom Application GB 2309523.5, filed Jun. 23, 2023, the entire contents of which are incorporated herein by reference.

### FIELD OF THE DISCLOSURE

The present application relates to a system and method for performing machine learning using a quantum computer.

### BACKGROUND

Machine learning (ML) research has developed into a mature discipline with applications that impact many different aspects of society. Neural network and deep learning architectures have been deployed for tasks such as facial recognition, recommendation systems, time series modelling, and for analysing highly complex data in science. In addition, unsupervised learning and generative modelling techniques are widely used for text, image, and speech generation tasks, which many people encounter regularly via interaction with chat bots and virtual assistants. Thus, the development of new machine learning models and algorithms can have significant consequences for a wide range of industries, and more generally, for society as a whole.

Recently, researchers in quantum information science have started to investigate whether quantum algorithms which are implemented on quantum computing hardware may offer advantages over conventional machine learning algorithms implemented on classical computing devices. This has led to the development of quantum algorithms for computational tasks associated with various aspects of ML, such as gradient descent, classification, generative modelling, reinforcement learning, as well as many other tasks. Further examples of the development of quantum systems for use in ML can be found in U.S. Pat. No. 11,157,828 and U.S. Patent Publication 2020/0279185.

However, in most cases it is not straightforward to generalize results from the conventional (classical) ML realm into the quantum ML realm. Rather, various factors must be reconsidered, such as data encoding, training complexity and sampling in the quantum machine learning (QML) setting. For example, there are some questions relating to how large data sets (such as may occur in many ML contexts) may be efficiently embedded into quantum states in such a way that a genuine quantum speedup is achieved. Furthermore, as quantum states prepared on quantum devices can only be accessed via sampling, one cannot estimate properties with arbitrary precision. One particular problem is gradient vanishing in the training of variational quantum algorithms, this is also known as “barren plateaus”. Accordingly, there is ongoing interest in further developing systems that include quantum computing platforms (also referred to herein as quantum hardware, quantum devices, quantum computers, quantum computing hardware and so on) to provide enhanced support for ML.

### BRIEF SUMMARY OF EMBODIMENTS

A system and method are provided for performing machine learning using a quantum computer. The method includes providing a model comprising a Quantum Boltzmann machine with a Hamiltonian ansatz having a set of operators and a set of parameters. The method further includes performing a first stage of training the model against data from a target using a selected subset of the set of operators to obtain optimized values for a subset of the set of parameters. The first stage of training is performed on classical computing hardware to provide a partly trained model. The method further includes performing a second stage of training the model against data from the target using a larger subset of the set of operators to obtain optimized values for a larger subset of the set parameters for the model. The second stage of training is at least partly performed using quantum computer hardware. The optimized parameter values from the first stage of training are used to initialize the corresponding parameters for the second stage of training.

The second stage of the training can be performed iteratively with a larger subset of operators and/or a larger subset of parameters in each iteration, to provide a trained Quantum Boltzmann Machine (hereinafter “QBM”) in which the difference in expectation values between parameter values of a target probability distribution and values of parameters output by the model is reduced. The first stage and second stage training, and potential further iterations, can provide a trained QBM that more accurately represents the Hamiltonian. We show that performance of incremental QBM learning can take advantage of recent and expected future advances in quantum computing hardware, as described below with reference to example quantum computing hardware.

By performing a first stage of training of a Quantum Boltzmann Machine (for example “pre-training” on a classical computing device, the second stage of training (and any subsequent iteration) starts with parameters that have been initialized to enable optimisation in the next stage of the training. A computer system for implementing embodiments may comprise classical binary computer hardware coupled to a quantum computer, making use of the resources of the classical computer for the first stage of training and then exploiting the quantum computer's probabilistic representation of quantum states of a target real-world quantum system for a second stage of training that improves the model.

### BRIEF DESCRIPTION OF THE FIGURES

Various examples and implementations of the disclosure will now be described in detail by way of example only with reference to the following figures:

FIG. 1 presents a high-level schematic diagram of an example of a method as disclosed herein for performing machine learning using a quantum computer.

FIGS. 2A, 2B and 2C (collectively referred to herein as FIG. 2), present schematic diagrams showing various results from using an example of a method as disclosed herein for performing machine learning.

FIG. 3 presents a high-level flowchart of an example of a method as disclosed herein for performing machine learning using a quantum computer.

FIG. 4 is a schematic diagram showing various hardware and software components of an example of the system described herein.

FIG. 5 presents two plots showing the minimum eigenvalue of a Hessian, as a function of the number of qubits, for a 1D nearest neighbour Hamiltonian and (b) for a fully-connected Hamiltonian.

### DETAILED DESCRIPTION OF EMBODIMENTS

### Overview

Quantum Boltzmann machines (QBMs) are machine-learning models which can be used with both classical and quantum data. An operational definition of QBM learning is presented in terms of the difference in Gibbs expectation values between the model and target, taking into account the polynomial size of the data set.

In other words, the QBM acts as a model which is trained to emulate a target. The target in effect defines a system and associated behaviour. In general, the target is not known per se, but samples of the system behaviour may be obtained. The QBM learning (training) involves obtaining samples of the target and corresponding samples from the QBM (model), and updating the model such that latter becomes more closely aligned with the former.

It is shown herein that with stochastic gradient descent, a machine learning solution may be obtained using at most a polynomial number of Gibbs states (where the Gibbs states can be regarded as providing samples of the model). One implication of this finding is that there are no barren plateaus in QBM learning (such as those without hidden units). It is also shown that pre-training on a subset of the QBM parameters can lower the sample complexity bounds. Various pre-training strategies are proposed based on mean-field, Gaussian Fermionic, and geometrically local Hamiltonians (additional models are available that likewise support training on a classical computer). The models and theoretical findings proposed herein have been verified numerically on a quantum and a classical data set. The results presented herein show that QBMs may provide promising machine learning models for training on present and future quantum devices.

In some implementations, a Hamiltonian ansatz is prepared that is very well suited for a particular quantum computing device. After exhausting all available classical computing resources during a first training phase (also referred to herein as pre-training), the model may be enlarged to continue the training on the quantum computing device to further enhance overall performance. As quantum hardware steadily matures, this supports the execution of deeper circuits and further increases of the model size. Incremental QBM training strategies may be designed to follow the quantum hardware road map towards training ever larger and more expressive quantum machine learning models.

### INTRODUCTION

As described herein, a system and method have been developed for training a quantum Boltzmann machine (QBM) to obtain optimal parameter values. The QBM training results in a model that emulates a target data set, and helps to address some of the issues identified above for implementing ML in a quantum environment. A QBM can be regarded as a generalisation of a classical Boltzmann machine, which is a form of stochastic neural network with nodes linked by weighted connections.

In particular, QBMs are physics-inspired ML models that generalize a classical Boltzmann machine to a quantum Hamiltonian ansatz (an ansatz can be considered as a trial solution to a given problem). A QBM can therefore be considered as providing a certain generic type of ML model, while the Hamiltonian ansatz particularizes the system to the given problem, for example by defining the input parameters for the QBM.

The (quantum) Hamiltonian ansatz can be defined on a graph where each vertex represents a qubit (or a qudit) and each edge represents an interaction (broadly, a qubit is a quantum computing counterpart of a hardware bit in a conventional/classical machine, whereas qudits can represent multi-level systems). The task is to learn the strengths of the interactions (weights), such that samples from the output quantum state of the QBM mimic samples taken from the target data set. For the present approach, the QBM may be trained with polynomial sample complexity on quantum computers. The power and benefits of such an approach will grow in parallel with the rapid development of quantum computing platforms (such as hardware systems that support increasing numbers of qubits and implement error detection or correction for fault tolerance).

The development of quantum generative models of this kind is expected to be useful in machine learning, for addressing (for example) science problems by learning approximate descriptions of the experimental data. QBMs may also play an important role as components of larger QML models (this is similar to how classical BMs can provide good weight initializations for the training of deep neural networks). One advantage of using a QBM rather than a classical BM is that a QBM is more expressive, since the Hamiltonian ansatz can contain more general non-commuting terms. This means that in some settings the QBM outperforms a classical BM, even for classical target data.

In order to help obtain results which have good practical relevance, an operational definition of QBM learning is adopted. Instead of focusing on an information-theoretic measure, we assess the QBM learning performance by the difference in Gibbs expectation values between the target and the model. This takes into account that the (classical) target data set comprises polynomially many data samples, hence its properties have a polynomial precision. Stochastic gradient descent methods are employed in combination with shadow tomography to show that this problem can be solved using polynomially many evaluations of the QBM model. Each evaluation of the model requires the preparation of one Gibbs state and, therefore, we refer to the sample complexity as the required number of Gibbs state preparations.

The Gibbs states used for QBM learning may be prepared and sampled on a quantum computer by a variety of methods. For present purposes, the focus is on the sampling complexity, rather than any specific Gibbs sampling implementation.

In practice, QBM learning allows for great flexibility in model design, and therefore time complexity. It is also shown below that the required number of Gibbs samples for QBM learning can be improved by pre-training on a subset of the parameters of the QBM. In other words, classically pre-training a simpler model can potentially reduce the (quantum) training complexity. For instance, it is possible to analytically pre-train a mean-field QBM and a Gaussian Fermionic QBM. In addition, it is shown below that a geometrically local QBM with gradient descent may be pre-trained, which provides some improved performance guarantees. As described herein, these exactly solvable models may be used for training and/or pre-training of QBMs. Further, classical numerical simulation results are presented which confirm the analytical findings.

### Problem Definition

We start by formally setting up the quantum Boltzmann machine (QBM) learning problem, providing the definitions of the target and model, and a description of how to assess the performance based on the precision of the expectation values. These definitions and assumptions help to obtain the results described herein, and are introduced below, along with their motivation. In addition, the problem definition described herein is compared to other related problems in the literature, such as quantum Hamiltonian learning.

We consider an n-qubit density matrix r as the target of the machine learning problem. If the target is classical, n could represent the number of features, e.g., the pixels in black-and-white pictures, or more complex features that have been extracted and embedded in the space of n qubits. If the target is quantum, n could represent spin-½ particles, but again more complex many-body systems can be embedded in the space of n qubits. In the literature, it is often assumed that algorithms have direct and simultaneous access to copies of η, however, this assumption is not adopted herein. Instead, a setup is considered in which access is limited to classical information about the target. For a data set [symbol] ={s^{μ}} of N independent data samples s^{μ}, and assuming the data set can be efficiently stored in a classical memory, the amount of memory required to store each data sample is polynomial in n, and there are polynomially many samples. For example, s may be bitstrings—this includes data sets like binary images and time series data, categorical and count data, and binarized continuous data. As another example, the data may originate from measurements on a quantum system. In this case s identifies an element of the positive operator-valued measure describing the measurement.

Next, we define the machine learning model which is used herein for data fitting. The fully-visible QBM is an n-qubit mixed quantum state of the form

$${ρ}_{θ} = \frac{{e}^{{ℋ}_{θ}}}{Z} , \qquad ( 1 )$$

where Z=Tr[ [symbol] ] is the partition function. The parameterized Hamiltonian is defined as

$${ℋ}_{θ} = {\sum }_{i = 1}^{m} {θ}_{i} {H}_{i} , \qquad ( 2 )$$

where θ∈ [symbol] ^{m} is the parameter vector, and {Hᵢ} is a set of m Hermitian and orthogonal operators acting on the 2ⁿ-dimensional Hilbert space. For example, these could be n-qubit Pauli operators, Fermionic operators, or any other suitable operator. As the true form of the target density matrix is unknown, the choice of operators {Hᵢ} in the Hamiltonian is chosen without certainty that the choice is optimal. It is possible that, once the Hamiltonian ansatz is chosen, the space of QBM models does not contain the target, i.e., ρ₀≠η, ∀θ. This is called a model mismatch, and it may be unavoidable in machine learning. In particular, since we require the number of operators m to be polynomial in n, ρ_{θ} cannot encode an arbitrary density matrix.

A natural measure to quantify how well the QBM ρ_{θ} approximates the target η is the quantum relative entropy:

$$S ( η ‖ {ρ}_{θ} ) = Tr [ η log η ] - Tr [ η log {ρ}_{θ} ] . \qquad ( 3 )$$

This measure generalizes the classical Kullback-Leibler divergence to density matrices. The relative entropy is exactly zero when the two densities are equal, η=ρ_{θ}, and S>0 otherwise. In addition, when S(η∥ρ_{θ})≤ϵ, by Pinsker's inequality, all possible Pauli expectation values are within [symbol] (\sqrt{ϵ}), see Appendix C.

In theory one can minimize the relative entropy S(η∥ρ_{θ}) in order to find the optimal model parameters θ^{opt}=argmin_{θ}S(η∥ρ_{θ}). The form of the partial derivatives of the relative entropy can be computed analytically and reads

$$\frac{\partial S ( η ‖ {ρ}_{θ} )}{\partial {θ}_{i}} = {H}_{i} {{ρ}_{θ}}_{} - {H}_{i} {η}_{} . \qquad ( 4 )$$

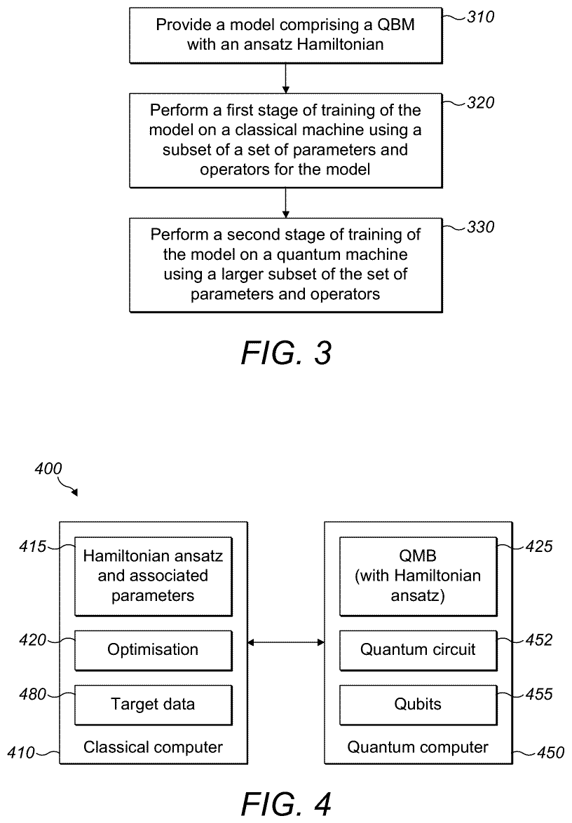

This is the difference between the target and model expectation values of the operators that are chosen in the ansatz. A stationary point of the relative entropy is obtained when [symbol] Hᵢ [symbol] _{τ}_{_{θ}}= [symbol] Hᵢ [symbol] _{η} for i∈{1, . . . , m}. Since S is strictly convex, see FIG. 3 below and Appendix B, this stationary point is the unique global minimum.

Quantifying how well the QBM is trained by means of the relative entropy has some issues in practice. An accurate estimate of S(η∥ρ_{θ}) generally involves access to the entropy of the target and the partition function of the model. Due to the model mismatch, which is expected because we are choosing m operators out of exponentially many potential operators, the optimal QBM may have S(η∥ρ_{θ}_{^{opt}})>0, and the optimal value is not known in advance. Therefore, in this work, an operational definition of QBM learning is based instead on the size of the gradient ∇S(η∥ ρ_{θ}).

Definition 1 (QBM learning problem). Given a polynomial-space data set {s^{μ}} obtained from an n-qubit target density matrix η, a target precision ϵ>0, and a fully-visible QBM with Hamiltonian [symbol] _{θ}=Σᵢ₌₁^{m}θᵢHᵢ, find a parameter vector θ such that with high probability

$$\vert {H}_{i} {{ρ}_{θ}}_{} - {H}_{i} {η}_{} \vert \leq ϵ , ∀ i . \qquad ( 5 )$$

A solution to the QBM learning problem always exists by Jaynes' principle: given a set of target expectations { [symbol] Hᵢ [symbol] _{η}}, there exists a Gibbs state ρ_{θ}_{^{opt}}=e^{Σθ}^{ᵢ}^{^{opt}}^{H}^{ᵢ}/Z such that [symbol] Hᵢ [symbol] _{ρ}_{_{θ}}ₒₚₜ− [symbol] Hᵢ [symbol] _{η}|=0, ∀i. However, due to the polynomial size of the data set we can only compute properties of the target (and model) to finite precision. (For example, suppose that s^{μ} are data samples from some unknown probability distribution P(s) and that we are interested in the sample mean. An unbiased estimator for the mean is

$$\hat{s} = \frac{1}{M} {\sum }_{μ = 1}^{M} {s}^{μ} .$$

The variance of this estimator is σ²/M, where σ² is the variance of P(s). By Chebyshev's inequality, with high probability the estimation error is of order σ/\sqrt{M}. The polynomial size of the data set implies that the error decreases polynomially in general). Therefore, we say the QBM learning problem is solved for any precision ε>0 in Equation (5), whereby the expectation values of the QBM and the target should be close enough that one cannot distinguish them without enlarging the data set.

The expectation values of the target can be obtained from the data set in various ways. For example, for the generative modeling of a classical binary data set one can define a pure quantum state and obtain its expectation values (see Appendix E). For the modeling of a target quantum state (density matrix) one can estimate expectation values from the outcomes of measurements performed in different bases.

As shown in Appendix C3, the solution to the QBM learning problem implies a bound on the optimal relative entropy, namely

$$S ( η ‖ {ρ}_{θ} ) - S ( η ‖ {ρ}_{{θ}^{opt}} ) \leq 2 ϵ {‖ θ - {θ}^{opt} ‖}_{1} . \qquad ( 6 )$$

This indicates that if the QBM learning problem can be solved to precision ϵ≤ϵ′/(2∥θ−θ^{opt}∥₁), one can also solve a stronger learning problem based on the relative entropy to precision ϵ′ (this involves bounding∥θ−θ^{opt}∥₁)

### Results

We approach the QBM learning problem by iteratively minimizing the quantum relative entropy, see Equation (3), in this example using stochastic gradient descent (SGD). This involves access to a stochastic gradient ĝ_{θ}_{^{t}} computed from a set of samples at time t, and the gradient has the form given in Equation (4) above. For the target expectation values in 4) above these are estimated from a random subset of the data set (sometimes referred to as a mini-batch). The mini-batch size is a hyper-parameter and determines the precision of ξ of each target expectation. Similarly, the QBM model expectations are estimated using classical shadows of the Gibbs state ρ_{θ}_{^{t}} approximately prepared on a quantum device. The number of measurements is also a hyper-parameter and determines the precision κ of each QBM expectation.

It is assumed that the stochastic gradient is unbiased, i.e., [symbol] [ĝ_{θ}_{^{t}}]=∇S(η∥ρ_{θ})|_{θ=θ}_{^{t}}, and that each entry of the vector has bounded variance. At iteration t, SGD updates the parameters as

$${θ}^{t + 1} = {θ}^{t} - {γ}^{t} {\hat{g}}_{{θ}^{t}} , \qquad ( 7 )$$

where γ^{t} is the learning rate.

With this method, the QBM learning problem may be solved with polynomial sample complexity. We state this in the following theorem, which is an important aspect of the approach described herein.

Theorem 1 (QBM training). We have a QBM defined by a set of n-qubit Pauli operators {Hᵢ}ᵢ₌₁^{m}, a precision κ for the QBM expectations, a precision ξ for the data expectations, and a target precision ϵ such that κ²+ξ²≥ϵ/2m. After

$$T = \frac{48 {δ}_{0} {m}^{2} ( {κ}^{2} + {ξ}^{2} )}{{ϵ}^{4}} \qquad ( 8 )$$

iterations of stochastic gradient descent on the relative entropy S(η∥ρ_{θ}) with constant learning rate

$${γ}^{t} = \frac{ϵ}{4 {m}^{2} ( {κ}^{2} + {ξ}^{2} )} ,$$

we have

$${min}_{t = 1 , … T} 𝔼 \vert {〈 {H}_{i} 〉}_{{ρ}_{{θ}^{t}}} - {〈 {H}_{i} 〉}_{η} \vert \leq ϵ , ∀ i , \qquad ( 9 )$$

where [symbol] [ . . . ] denotes the expectation with respect to the random variable θ^{t}. Each iteration t∈{0, . . . , T} involves

$$N ∈ 𝒪 ( \frac{1}{{κ}^{4}} log \frac{m}{1 - {λ}^{\frac{1}{T}}} ) \qquad ( 10 )$$

preparations of the Gibbs state pet, and the success probability of the full algorithm is λ. Here, δ₀=S(η∥ρ_{θ}_{⁰})−S(η∥ρ_{θ}_{^{opt}}) is the relative entropy difference with the optimal model ρ_{θ}_{^{opt}}.

The success probability is the probability that the QBM expectation values are determined correctly. It is a free parameter which can be set to a value for performing the experiment and determines how many measurements are to be performed.

A detailed proof of this theorem is given in Appendix C2 and includes carefully combining three important observations and results. First, it is shown that the quantum relative entropy for any QBM ρ_{θ} is L-smooth with L=2m maxⱼ∥Hⱼ∥₂². This is then combined with SGD convergence results from the machine learning literature to obtain the number of steps T. Finally, sampling bounds from quantum shadow tomography are used to obtain the number of preparations N. This last step focuses on the shadow tomography protocol, which normally restricts the results to Pauli observables Hᵢ≡Pᵢ, thus ∥Hᵢ∥₂=1. It is possible to extend this to generic two-outcome observables with a polylogarithmic overhead compared to Equation (10), see Appendix C2. Furthermore, for k-local Pauli observables, we can improve the result to

$$N ∈ 𝒪 ( \frac{{3}^{k}}{{κ}^{{}_{2}}} log \frac{m}{1 - {λ}^{1 / T}} ) \qquad ( 11 )$$

with classical shadows constructed from randomized measurement or by using pure thermal shadows.

By combining Equations (8) and (10), we see that the final number of Gibbs state preparations Nₜₒₜ≥T×N scales polynomially with m, the number of terms in the QBM Hamiltonian. According to our assumption of classical memory, we can only have m∈ [symbol] (poly(n)). This means that the number of required measurements to solve QBM learning scales polynomially with the number of qubits (features). Consequently, there are no barren plateaus in the optimization landscape for this problem, where a barren plateau of a loss function f(θ) is defined by the vanishing of its gradient E[∇_{θ}f(θ)]=0, and also by an exponentially decreasing variance of the gradient var[∇_{θ}f(θ)]<O(2⁻ⁿ).

The following theorem is proved in Appendix C2.

Theorem 2 (α-strongly convex QBM training). We have a QBM defined by a Hamiltonian ansatz [symbol] _{θ} such that S(ƒ∥ρ_{θ}) is α-strongly convex, a precision κ for the QBM expectations, a precision for the data expectations, and a target precision ϵ such that κ²+ξ²≥ϵ/2m.

After

$$T \geq \frac{18 {m}^{2} ( {κ}^{2} + {ξ}^{2} )}{{α}^{2} {ϵ}^{2}} \qquad ( 12 )$$

iterations of stochastic gradient descent on the relative entropy S(η∥ρ_{θ}) with learning rate

$${γ}^{{}_{t}} \leq \frac{1}{4 {m}^{2}}$$

(see Appendix C.2 for the specific learning rate schedule), we have:

$${min}_{t = 1 , … T} 𝔼 \vert {〈 {H}_{i} 〉}_{{ρ}_{{θ}^{t}}} - {〈 {H}_{i} 〉}_{η} \vert \leq ϵ , ∀ i . \qquad ( 13 )$$

Each iteration involves the number of samples given in Equation (10).

The sample bound in Theorem 1 depends on δ₀, the relative entropy difference of the initial and optimal QBMs. This means that if we can lower the initial relative entropy, we also tighten the bound on the QBM learning sample complexity. In this respect, it is shown that δ₀ can be reduced by pre-training a subset of the parameters in the Hamiltonian ansatz. Thus, pre-training reduces the number of steps to reach the global minimum.

Theorem 3 (QBM pre-training). Assume a target η and a QBM model ρ_{θ}=e^{Σ}^{ᵢ}^{θ}^{ᵢ}^{H}^{ᵢ}/Z for which we seek to minimize the relative entropy S(η∥ρ_{θ}). Initializing at θ⁰=0 and pre-training S(η∥ρ₀) on any subset \tilde{m}≤m of the parameters (Hamiltonian operators {Hᵢ}ᵢ₌₁^{\tilde{m}}) ensures that

$$S ( η \vert \vert {p}_{{θ}^{p r e}} ) \leq S ( η \vert \vert {p}_{{θ}^{0}} ) , \qquad ( 14 )$$

where θ^{pre}=[χ^{pre},0_{m-\tilde{m}}] and the vector χ^{pre} of length \tilde{m} contains the parameters for the terms {Hᵢ}ᵢ₌₁^{\tilde{m}} at the end of pre-training. More precisely, starting from

$${ρ}_{χ} = {e}^{{\sum }_{i = 1}^{\tilde{m}} {\sum }_{i} {χ}_{i} {H}_{i}} / Z$$

and minimizing S(η∥ρ_{θ}) with respect to χ ensures Equation (14) for any S(η∥ρ_{χ}_{^{pre}})≤S(η∥ρ_{χ}_{⁰}).

We provide a detailed proof of Theorem 3 in Appendix D.1 which applies to any method that is able to minimize the relative entropy with respect to a subset of the parameters. All the other parameters are fixed to specific particular values, generally (but without limitation) zero, and the pre-training starts from the maximally mixed state II/2ⁿ. For example, one could use SGD as described above, and apply updates only to the chosen subset of parameters. With a suitable learning rate, this ensures that pre-training lowers the relative entropy compared to the maximally mixed state S(η|II/2n). As a consequence, it is possible to add additional, linear independent, terms to the QBM ansatz without having to retrain the model from scratch. The performance is guaranteed to improve, specifically towards the global optimum due to the strict convexity of the relative entropy. This is in contrast to other QML models which do not have a convex loss function. This is particularly useful if a certain subset of the QBM ansatz is pre-trained classically before training the full model on a quantum device. For example, in Appendix D.2 mean-field and Gaussian Fermionic QBM pre-training models are presented with closed-form expressions for the optimal subset of parameters.

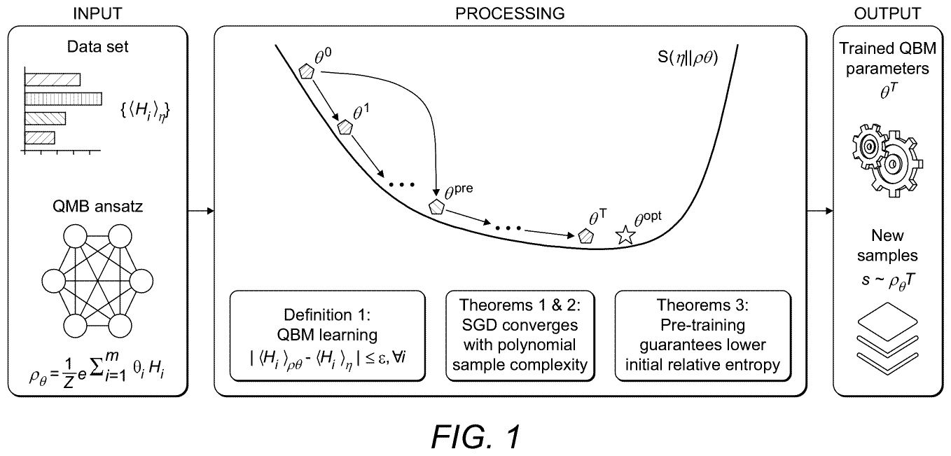

FIG. 1 presents a high-level schematic diagram of an example of a method as disclosed herein for performing machine learning using a quantum computer. FIG. 1 comprises three boxes—the left-hand box depicts the inputs, the right-hand box depicts the outputs, and the central box depicts the processing used to derive the outputs from the inputs.

In particular, the input data comprises two components. The first component is a QBM associated with a Hamiltonian ansatz. This first component in effect represents the ML model which is to be trained. The second component comprises a set of data values (samples), which represent Hamiltonian expectation values for the target. For example, the data may represent measurements performed on a target quantum system. This set of samples has a polynomial size with respect to the size of the QBM (which corresponds to the number of qubits used for a quantum-based implementation of the QBM). This polynomial scaling converges using accessible levels of computing resources.

The output data (right-hand image) corresponds to the QBM and ansatz Hamiltonian model shown as the input data (left-hand image) after training the QBM mode using the target data set also shown in the input data. The right-hand image also depicts new samples s˜ρ_{θ}_{^{T}} which are sample outputs provided by the trained QBM.

The central box in FIG. 1 represents training the QBM model based on the data set from the target. This training is, in this example, performed using stochastic gradient descent (SGD) based on the relative entropy level between the target and the model. Thus FIG. 1 shows a sequence of models θ⁰, θ¹ . . . θ^{T} in effect representing successive generations of the trained QBM model. A minimum is taken to occur when the difference between the model Hamiltonian expectation and the target Hamiltonian expectation is less than a set threshold, ϵ, for each sample i (see Definition 1). For θ^{opt}, ϵ=0, is the exact solution given by Jaynes principle. In theory this is the best solution that can ever be achieved with SGD, in reality SGD cannot get arbitrarily close and is happy to achieve a fixed (specified) precision ϵ>0 corresponding to θ^{T}.

As discussed herein, in the procedure shown in FIG. 1, pre-training on a classical computer may be utilized to lower the relative entropy, thereby facilitating subsequent full (quantum-based) training, which can be initialized according to the lower relative entropy configuration produced by the pre-training.

The central box of FIG. 1 shows an operational definition of the QBM learning problem in terms of expectation values, namely | [symbol] Hᵢ [symbol] _{ρ}_{_{θ}}− [symbol] Hᵢ [symbol] _{η}|≤ϵ, ∀i, whereby the respective model and target expectations must be close to within a polynomial precision ϵ (see Theorems 1 and 2). As shown herein, the QBM learning can then be solved by minimizing the quantum relative entropy S(η∥ρ_{θ}) with SGD and using a polynomial number of Gibbs states (see Theorems 1 and 2). It is further shown with Theorem 3 that the pre-training strategies which optimize a selected subset of the QBM parameters are guaranteed to lower the initial quantum relative entropy. The SGD algorithm outputs the QBM model parameters θ^{T} in a polynomial number of steps (iterations) T, and these can be used as a trained system for using samples of new data to provide predicted outcomes.

Accordingly, FIG. 1 shows a configuration in which the problem input is a data set of size polynomial in the number of features/qubits, and an ansatz for the QBM model with parameters θ. In Definition 1 an operational definition is provided of the QBM learning problem where the model and target expectations must be close to within a polynomial precision ϵ. A solution θ^{opt} is guaranteed to exist by Jayne's principle. With Theorems 1 and 2 it is established that QBM learning can be solved by minimizing the quantum relative entropy S(η∥ρ_{θ}) with respect to θ using SGD. This involves a polynomial number of Gibbs state preparations. With Theorem 3, it is shown that pre-training strategies that optimize a subset of θ^{pre} of the QBM parameters are guaranteed to lower the initial quantum relative entropy. The algorithm outputs a solution θ^{T} to the problem in a polynomial number of steps T. The trained QBM can be used, for example, to generate new synthetic data.

### Numerical Experiments

To further investigate the above theoretical findings, numerical experiments were performed of QBM learning on data sets constructed from a quantum source and a classical source. First, we focus on reducing the initial relative entropy S(η∥ρ_{θ}_{⁰}) by QBM pre-training, following Theorem 3. Mean-field (MF), Gaussian Fermionic (GF), and geometrically local (GL) models are considered as potential pre-training strategies. The Hamiltonian ansatz of an MF model includes all possible one-qubit Pauli terms {Hᵢ}ᵢ₌₁³ⁿ={σᵢ^{x},σᵢ^{y},σᵢ^{z}}ᵢ₌₁ⁿ as per Equation (2) and hence has 3n parameters. The Hamiltonian of the GF model has a quadratic form [symbol] _{θ}^{GF}=Σ_{i,j}\tilde{θ}ᵢₘ\vec{C}ᵢ^{†}\vec{C}ⱼ of Fermionic creation and annihilation operators, where \tilde{θ}ᵢⱼ is the 2n×2n Hermitian parameter matrix which has n² free parameters. Here \vec{C}^{†}=[c₁^{†}, . . . , cₙ^{†}, c₁, . . . , cₙ], with the operators satisfying {cᵢ,cⱼ}=0 and {cᵢ^{†},cⱼ}=δᵢⱼ, where {A,B}=AB+BA is the anti-commutator. The advantage of the MF and GF pre-training is that there exists a closed-form solution given target expectation values [symbol] Hᵢ [symbol] _{η}. This is shown in Appendix D.

In contrast, the GL models are defined with a Hamiltonian ansatz

$${ℋ}_{θ}^{G L} = {\sum }_{k = x , y , z} {\sum }_{〈 i , j 〉} {λ}_{i j}^{k} {σ}_{i}^{k} {σ}_{j}^{k} + {\sum }_{i}^{n} {γ}_{i}^{k} {σ}_{i}^{k} , \qquad ( 15 )$$

for which, in general, the parameter vector \vec{θ}≡{λ,σ} cannot be found analytically. Here the sum [symbol] i,j [symbol] imposes some constraints on the (geometric) locality of the model, i.e., summing over all possible nearest neighbors in some d-dimensional lattice. In particular we choose one- and two-dimensional locality constraints suitable with the assumptions given in the literature. In these specific cases the relative entropy is strongly convex, thus pre-training with SGD has the improved performance guarantees from Theorem 2.

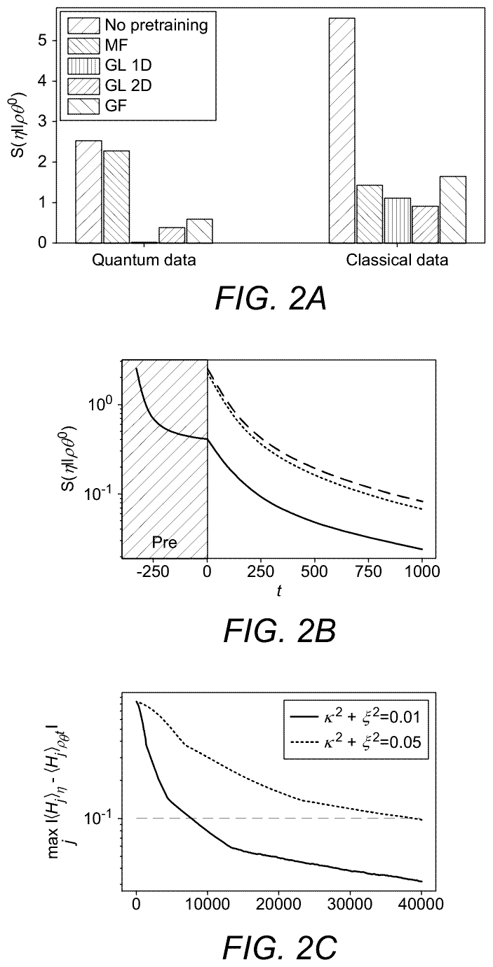

FIGS. 2A, 2B and 2C (collectively referred to herein as FIG. 2) present schematic diagrams showing various results from using an example of a method as disclosed herein for performing machine learning. FIG. 2A shows the initial relative entropy S(η∥ρ_{θ}_{^{pre}}) (y-axis) after various forms of pre-training using models for two 8-qubit problems. In particular, the forms of training in FIG. 2A are a mean-field (MF) model, a one-dimensional and two-dimensional geometrically local (GL) model, and a Gaussian Fermionic (GF) model. FIG. 2A further shows a comparison to the situation without pre-training (a maximally mixed state).

In the left-hand portion of FIG. 2A, the pre-training is performed with quantum data (e.g. data produced by quantum hardware); in the right-hand portion of FIG. 2A, the pre-training is performed with classical data. An 8-qubit target η= [symbol] /Z is used as the Gibbs state of the one-dimensional XXZ model for the Quantum Data, and a target η which coherently encodes the binary salamander retina data was adopted for the Classical Data.

As mentioned above, FIG. 2A also shows the results without any pre-training, i.e., starting from a maximally mixed state S(η∥ρ_{θ=0}). In all cases, it can be seen from FIG. 2A that pre-training provides a reduction in the initial relative entropy for subsequent training of the model on quantum hardware. This reduction is particularly strong for classical data. For quantum data, the situation is a little more mixed, in that the reduction in relative entropy is rather modest for pre-training based on a mean-field, but is much more prominent for the other forms of pre-training shown in FIG. 2A.

Accordingly, it is observed for both targets (quantum data and classical data) that all pre-training strategies are successful in reducing S(η∥ρ_{θ}_{^{pre}}), with a slightly better performance for the classical target. For the GL 1D ansatz, the target state is contained within the QBM model space, which means that the relative entropy becomes zero after pre-training using quantum data. This shows that having knowledge about the target (e.g., the fact that it is one-dimensional) may help to inform QBM ansatz design and significantly reduce the complexity of QBM learning. The Fermionic model, which has completely different terms in the ansatz, manages to reduce S(η∥ρ_{θ}_{^{pre}}) by a factor of ≈5 for the quantum target and ≈4 for the classical target. By the Jordan-Wigner transformation, a 1D quantum XXZ target can be expressed in the Fermionic basis. In this representation, the target only has a small perturbation compared to the model space of the GF model—this at least partially explains the good performance of pre-training with the GF model.

The effect of using the pre-trained models as a starting point for QBM learning with exact gradient descent was investigated for a fully-connected QBM with

$${ℋ}_{θ} = {\sum }_{k = x , y , z} {\sum }_{i , j > i} {λ}_{i j}^{k} {σ}_{i}^{k} {σ}_{j}^{k} + {\sum }_{i}^{n} {γ}_{i}^{k} {σ}_{i}^{k} . \qquad ( 16 )$$

In this context (compared to Equation (15)), any qubit can be connected to any other qubit, and there is no constraint on the geometric locality. This is a QBM Hamiltonian known in the literature. We consider data from the quantum target η= [symbol] /Z for 8 qubits.

In FIG. 2B, the decay of quantum relative entropy (y-axis) is plotted against the number of learning iterations (t, x-axis) for training that starts from various pre-training strategies as per FIG. 2A. We define θ⁰ as the parameter vector at the end of pre-training, whereby ρ_{θ}_{⁰}:=ρ_{θ}_{^{pre}}. The lines in FIG. 2B match the form of pre-training shown in FIG. 2A—the top line represents no pre-training, the slightly lower middle line is MF (mean-field), and the lowest line is GL (geometrically local) 2D. The left-hand portion of FIG. 2B (hatched background) shows the pre-training phase, while subsequent training on (simulated) quantum hardware is shown in the centre and right-hand portion of FIG. 2B (unhatched light background). The quantum data (from the left portion of FIG. 2A) is used in FIG. 2B and noise is not taken into account, i.e., κ=ξ=0. Indeed, the GL 2D model requires pre-training with noise-free gradient descent, for which the relative entropy reduction is shown in the hatched area. A pre-training learning rate of γ=1/\tilde{m} was used along with a learning rate of γ=1/(2m) in order to satisfy the assumptions in Theorems 1 and 3.

The performance of the MF pre-trained model (middle line) is better than the top line corresponding to no pre-training at all iterations, but the improvement is relatively modest. Using a 2D GL model (bottom line) for pre-training has a much more significant effect, with S(η∥ρ_{θ}_{^{t}}) being an order of magnitude smaller than for the model without pre-training at all steps t. Furthermore, the 2D GL pre-training strategy involves very few gradient descent steps (see the hatched area). This may potentially stem from the strong convexity of this particular pre-training model. Note that in general the benefits of pre-training should be assessed on a case by case basis, as the size of the improvement depends on the particular target and the particular pre-training model used. In this respect, it is noted that Theorem 1 has been proved for a learning rate of

$$γ = min \{ \frac{1}{L} , \frac{ϵ}{4 {m}^{2} ( {κ}^{2} + {ξ}^{2} )} \} .$$

Therefore, choosing a larger learning rate might reduce the benefits of pre-training.

FIG. 2C plots the maximum error in the expectation values (model compared to target) on the y-axis. This phase of the training is performed on simulated quantum hardware with no noise, and is plotted versus the number of iterations of SGD (x-axis). Classical input data is used (as per the right-hand component of FIG. 2A) and two different noise strengths compared—the lower line corresponds to less noise (0.01) while the upper line corresponds to greater noise (0.05). A learning rate is used of γ=ϵ/(2m²(κ²+ξ²)). The dashed line indicates the target precision of ϵ=0.1. Expectation values of the Gibbs state for the 1D quantum XXZ model in an external field and expectation values of a classical salamander retina data set are used as targets. The specifics of these models and how to compute the expectation values for classical data are given in Appendix E.

The bound on the number of SGD updates, as per Equation (8) for Theorem 1, was numerically confirmed. This involved considering data from the classical salamander retina target with 8 variables and a fully-connected QBM model on 8 qubits. As noted above, FIG. 2C compares training with two different noise strengths κ²+ξ². These settings were implemented by adding Gaussian noise, but in reality (rather than simulations) the noise strength would be determined by the number of data points and measurements of the Gibbs state on a quantum device. Using a standard Monte Carlo estimate, each update includes a mini-batch of data samples of size 1/ξ², and a number of measurements 1/κ² (assuming these measurements can be performed without additional hardware noise). Potentially mini batches of size 1 and a single measurement could be used as long as the Gibbs state expectation values are unbiased. For both noise strengths, the desired target precision of ϵ=0.1 was obtained within 104 steps. This is well within the bound [symbol] (10⁹) on the number of steps in Theorem 1, which is the worst case scenario.

### Discussion and Conclusion

An operational definition of quantum Boltzmann machine (QBM) learning has been developed and it is shown that this problem can be solved with polynomially many preparations of quantum Gibbs states. To prove the relevant bounds, the properties of the quantum relative entropy are used in combination with the performance guarantees of stochastic gradient descent (SGD). There is no assumption as to the form of the QBM Hamiltonian, other than that it consists of polynomially many terms. This is in contrast with some earlier works that looked at the somewhat related Hamiltonian learning problem only for geometrically local models. In that context, strong convexity is required in order to relate the optimal Hamiltonian parameters to the Gibbs state expectation values. In the machine learning setting described herein, the form of the target Hamiltonian is not known a priori. Therefore, learning the exact parameters is not as directly relevant, and instead the focus is directly on the expectation values. For this reason, the bounds for the approach described herein only involve L-smoothness of the relative entropy and may be applied to all types of QBMs without hidden units.

It is also shown herein that the theoretical sampling bounds may be tightened by lowering the initial relative entropy of the learning process. Typically, one would start QBM learning from the maximally mixed state, i.e., the state with no prior information. It is shown herein that pre-training on any subset of the parameters performs better than (or equal to) the maximally mixed state. This is beneficial if one can efficiently perform the pre-training, as is shown herein to be the case for mean-field, Gaussian Fermionic, and geometrically local QBMs. The performance of these models and the theoretical bounds are verified with classical numerical simulations. These simulations also indicate that knowledge about the target (e.g., its dimension, degrees of freedom, etc.) can significantly improve the training process. Furthermore, it is found that the generic bounds adopted herein are quite loose, and in practice it may be feasible to use a much smaller number of samples.

In some implementations, the sample bound may be tightened by going beyond the plain SGD method described so far. This could be done in various ways, such as by adding momentum, by using other advanced update schemes, and/or by exploiting the convexity of the relative entropy. This may improve the

$$𝒪 [ poly ( m , \frac{1}{ϵ} ) ]$$

scaling in our bounds, and generally conforms to the approach described herein, whereby the QBM learning problem can be solved with polynomially many preparations of Gibbs states.

Another point of interest concerns training performance of different ansatz. Generative models are often assessed in terms of training quality and generalization capabilities have recently been investigated by both classical and quantum machine learning researchers. For the case of QBMs, generalization may offer a path for further development.

The operations and results described herein may also be generalized to QBM models with hidden units. This generalization could involve showing L-smoothness of the relative entropy for a more general and challenging setup, and a positive result would provide a facility to train highly expressive models. In this respect, it is noted that the results presented herein already hold for the special case of a QBM with fixed hidden units, since this problem reduces to the one discussed above.

The pre-training result described herein may be useful for implementing QBM learning on near-term and early fault-tolerant quantum devices. To this end, a quantum computer may be used as a Gibbs sampler. There are many quantum algorithms in the literature that produce Gibbs states with a quadratic improvement in time complexity over the best existing classical algorithms. Moreover, the use of a quantum device gives an exponential reduction in space complexity in general. For example, Motta et al. implemented a 2 qubit Gibbs state for an anti-ferromagnetic Ising model Hamiltonian on the Aspen-1 quantum computer. It is anticipated that improved quantum processing devices with higher gate fidelities and higher qubit counts, such as (but not limited to) Quantinuum's system model H2 or the Aspen-M-3, may be able to prepare similar Gibbs states and potentially for more complex Hamiltonians (i.e. with more operators in the ansatz). A further possibility is to sidestep the Gibbs state preparation and use algorithms that directly estimate Gibbs-state expectation values, e.g., by constructing classical shadows of pure thermal quantum states. This reduces the number of qubits and, potentially, the circuit depth.

The results presented herein support a range of methods for incremental learning QBMs driven by the availability of both training data and quantum hardware. For example, one could select a Hamiltonian ansatz that is very well suited for a particular quantum device. After exhausting all available classical resources during the pre-training, the model may be enlarged, and the training then continues on a quantum device, which therefore improves the overall performance. As quantum hardware matures, it allows the execution of deeper circuits and so supports a further increase of the model size. Incremental QBM training strategies may be designed to follow the quantum hardware road map towards training larger and more expressive quantum machine learning models.

### Example Implementations

The results presented herein support the development of methods for incremental learning by QBMs driven by the availability of both training data and quantum hardware. For example, one could select a Hamiltonian ansatz that is very well suited for a particular quantum device. After exhausting all available classical resources during the pre-training phase on selected components of the model (such as by selecting subsets of the operators and parameters), the model is enlarged and continues the training on the quantum device, which is guaranteed to improve the performance (compared to the output at the end of the pre-training phase). As quantum hardware continues to develop further, this allows the execution of deeper circuits and a further increase in the model size. Incremental QBM training strategies may be designed to follow the quantum hardware road map, towards training larger and more expressive quantum machine learning models.

FIG. 3 presents a high-level flowchart of an example of a method as disclosed herein for performing machine learning using a quantum computer. Operation 310 comprises providing a model comprising a Quantum Boltzmann machine with an ansatz Hamiltonian having a set of operators and a set of parameters.

The Quantum Boltzmann machine with an ansatz Hamiltonian may be further provided with target expectation values for performing the first stage of training. For example, a QBM ρ_{θ} with ansatz Hamiltonian may be given by a set of operators {Hᵢ}ᵢ₌₁^{m}, parameters {θᵢ}ᵢ₌₁^{m}, and the target expectation values {Hᵢ}_{η}.

Operation 320 performs a first stage of training the model against data from a target using a selected subset of the operators to obtain optimized values for a subset of the parameters. The first stage of performing is performed on classical computing hardware to provide a partly trained model.

In the first stage of training, a subset \tilde{m} may be selected of the operators {Hᵢ}ᵢ₌₁^{\tilde{m}}, that can be trained classically. The selection of a subset of operators of a Hamiltonian may have regard to the operators that can be efficiently trained in a classical context. The relative entropy may be optimized on classical hardware with respect to a selected subset of the parameters while keeping other parameters set to zero (or any other suitable values). The optimal parameters obtained after the classical pre-training (having exhausted the available classical resources) may be saved. The pre-training may be iterated over t=1 to Tₚᵣₑ, where Tₚᵣₑ represents a maximum number of iterations (if convergence does not occur beforehand). This pre-training seeks to optimize the relative entropy S(ηρ_{θ}) with respect to the subset {θᵢ}ᵢ₌₁^{\tilde{m}} of parameters while keeping the other (non-selected) parameters set to a fixed value such as zero.

Operation 330 performs a second stage of training the model against data from the target using the full set of operators to obtain optimized values for a larger subset of the set of parameters for the model. The second stage of performing is performed on quantum computer hardware to provide a further trained model. The optimized parameter values saved from the first stage may be used to initialize the corresponding parameters for the second stage of training.

The larger subset of the set of parameters for the model may, in some implementations, comprise the full set of parameters for the model. Accordingly, the second phase of training may encompass all the set of parameters for the model. (It is implicit that the first phase of training does not involve training all the parameters of the set, because this would not allow the second phase of training to involve a larger subset.

The second phase of training may be iterated over t=1 to T_{q1}, where T_{q1} represents a maximum number of iterations (if convergence does not occur beforehand). In this second phase of training, the relative entropy may be optimized with respect to all the parameters in the model and target by computing Gibbs state expectation values on a quantum device. Before performing this optimization, the ansatz Hamiltonian is extended with a further set of operators and parameters (enlarging the model). These further operators and parameters are those that were not included in their respective subsets during the pre-training phase (and so have not yet been incorporated into the model).

Accordingly the second phase optimizes the relative entropy S(η|ρ_{θ}) with respect to all of the parameters {θᵢ}ᵢ₌₁^{m} by computing the Gibbs state expectation values {Hᵢ}_{ρθ} on a quantum device, such as by using thermal shadows. The parameters of the extended (complete) QBM may be initialized using the optimal values obtained at the end of the previous quantum optimization loop (iteration). As noted above, for the first iteration, the parameters are initialized using the optimal values from the first stage of training (the pre training). For each iteration on the quantum hardware, the additional target expectation values are determined to optimize the relative entropy with respect to all the extended QBM parameters by obtaining the required Gibbs state expectation values on the quantum hardware.

Depending on the quantum computing resources available, the above approach may be developed further such that in a third training phase, the ansatz Hamiltonian is further extended with a set of (orthogonal) operators {\tilde{H}ᵢ}ᵢ₌₁ⁿ and parameters {\tilde{θ}ᵢ}ᵢ₌₁ⁿ. The parameters of the extended QBM are initialized as λ≡{θ,\tilde{θ}}={θₒₚₜ,0}, where θₒₚₜ are the optimal parameters obtained at the end of the previous quantum optimization loop. The additional target expectation values [symbol] \tilde{H}ᵢ [symbol] _{η} are computed and used for the training.

In this further development, the third phase of training may be iterated over t=1 to T_{q2}, where T_{q2} represents a maximum number of iterations. Each iteration then involves an optimization of the relative entropy S(η∥ρ_{λ}) with respect to all the extended QBM parameters λ by obtaining the required Gibbs state expectation values on a quantum device.

In some implementations, the second stage of the training (and/or the third stage of the training if relevant) may be performed on a hybrid system which includes both quantum computing hardware and classical computing hardware. For example, Gibbs states for the Quantum Boltzmann machine may be used to provide samples for machine learning. The Gibbs states may be prepared and sampled on the quantum computing hardware, whereas the parameters for the model may be maintained on classical computing hardware. Various other configurations of a hybrid system may also be used for the second and/or third training stages.

FIG. 4 is a schematic diagram showing various hardware and software components of an example of a system 400 described herein for machine learning. In particular, the system 400 comprises a classical computing platform 410 and a quantum computing platform 450. The classical computing platform 410 may comprise a known form of digital computer(s) including one or more processors for executing program instructions and memory for storing the program instructions and data. The quantum computing platform may comprise a known form of one or more quantum computers. It will be appreciated that the components and configuration shown in FIG. 4 are presented by way of example only and not by way of limitation.

FIG. 4 depicts three particular components implemented using the classical computing platform 410, namely a Hamiltonian ansatz 415, an optimization program 420, and a set of target data 480. The Hamiltonian ansatz 415 is structured in accordance with a Quantum Boltzmann Machine (QBM) and represents a model, for example relating to a complex physical system. The Hamiltonian 415 incorporates a set of operators and a set of parameters. The machine learning involves determining values for the set of parameters such that the output of the model, as represented by expectation values of the operators, mimics (largely coincides with) the system, which is being modelled, as represented by the target data 480.

The classical computing platform 410 further includes an optimization (minimization) program 420, for example a program which performs stochastic gradient descent (SGD). In broad terms, the optimization program 420 may obtain samples, as represented by expectation values of the operators in the Hamiltonian ansatz 415, for comparison with training data, namely target data 480. The optimization program uses the results of these comparisons to update the parameters of the Hamiltonian ansatz 415 so as to reduce quantum relative entropy. The optimization program 420 performs multiple iterations of this machine learning process to reach a configuration of the model parameters which has a low (minimal) quantum relative entropy.

The first stage of the process (pre-training) is performed solely on the classical computing device 410. Such a device may not have enough processing capability to perform the whole optimization procedure. Thus, as described herein, the pre-training may be performed, for example, with respect to a subset of the model parameters. The remaining parameters (those not in subset) may be held at a fixed value, such as zero. Using a subset of the parameters for the optimization such as using SGD generally reduces the computational resources used for this second stage of training.

The second stage of the process (after the pre-training) involves the use of the quantum computing platform 450. The quantum computing platform 450 includes a quantum circuit 452 associated with one or more qubits 455 to support computations running on the quantum computing platform 450. The quantum computing platform 450 also includes a QBM 425 associated with the Hamiltonian ansatz. This Hamiltonian on the quantum computer 450 generally matches the Hamiltonian ansatz 415 on the classical computing device 410, especially in terms of the associated model, but they are adapted to run on different hardware platforms as shown in FIG. 4. For example, the QBM 425 may be implemented using the quantum circuit 452 of the quantum computing platform 450.

In the example of FIG. 4, the optimization program 420 is also used to control the optimization procedure in the second stage in a similar manner to the first stage. Accordingly, the second stage can be regarded as hybrid, in that it involves computing operations on both the classical computing platform 410 and the quantum computing platform 450. The optimization program 420 (such as SGD) provides parameters to the QBM 425 and compares the QBM output with training data (target data 480), which can then be used to determine machine learning updates.

By measuring the physical properties of the QBM (425) prepared on the quantum device (450), the optimizer (SGD) can search in parallel across parameter space to find parameter values that have the lowest relative entropy. This ability may offer the potential of performing machine learning on the quantum computer 450 that is not computationally feasible on a classical computer 410 (or is more computationally expensive on a classical computer). For example, the second phase of the searching may be performed with a larger subset (or complete set) of the parameters for the model. Accordingly, the approach described herein exploits the different properties and characteristics of classical and quantum computing devices to support an efficient approach for machine learning with respect to complex systems.

Various implementations and examples have been disclosed herein. It will be appreciated that these implementations and examples are not intended to be exhaustive, and the skilled person will be aware of many potential variations and modifications of these implementations and examples that fall within the scope of the present disclosure. It will also be understood that features of particular implementations and examples can typically be incorporated into other implementations and examples (unless the context clearly indicates to the contrary). In summary, the various implementations and examples herein are disclosed by way of illustration rather than limitation, and the scope of claimed embodiments is defined in the appended claims.

### APPENDICES

### Appendix A: Preliminaries: Some Useful Mathematical Facts and Relations

Here we identify some useful mathematical facts and relations and derive some useful results that are used in the proofs in later appendices.

### 1. Convexity

Definition 2 (Convexity). A multivariate function ƒ: [symbol] ^{m} [symbol] [symbol] is said to be convex when

$$f ( t x + ( 1 - t ) y ) \leq t f ( x ) + ( 1 - t ) f ( y ) , ∀ x , y ∈ {ℝ}^{m} , t ∈ [ 0 , 1 ] . \qquad ( A1 )$$

If additionally the gradient ∇ƒ(x*) is zero only for one unique vector x*∈ [symbol] ^{m}, then ƒ is said to be strictly convex.

The following Lemma can be deduced from the standard definition of convexity; see Garrigos et al., “Handbook of Convergence Theorems for (Stochastic) Gradient Methods”, arXiv:2301.11235, 2023 (hereinafter “Garrigos”).

Lemma 1. Let ƒ be twice continuously differentiable. Then ƒ is convex if

$${v}^{{}_{T}} {∇}^{2} f ( x ) v \geq 0 , ∀ x , v ∈ {ℝ}^{m} . \qquad ( A2 )$$

A stronger version of convexity is used in some of our discussions.

Definition 3 (α-Polyak-Lojasiewicz). Let ƒ: [symbol] ^{M}→ [symbol] , and α>0. We say that ƒ is α-Polyak-Lojasiewicz if

$$\frac{1}{2 α} {‖ ∇ f ( x ) ‖}^{2} \geq f ( x ) - {min}_{x} f ( x ) . \qquad ( A3 )$$

Where ∥⋅∥ is the Euclidean norm.

An even stronger convexity condition is the following.

Definition 4 (α-strong convexity). Let ƒ: [symbol] ^{m}→ [symbol] , and α>0. We say that ƒ is α-strongly convex if

$$\frac{α t ( 1 - t )}{2} {‖ x - y ‖}^{2} + f ( t x + ( 1 - t ) y ) \leq tf ( x ) + ( 1 - t ) f ( y ) . \qquad ( A 4 )$$

The former implies the latter

Lemma 2. If ƒ is α-strongly convex then ƒ is α-Polyak-Lojasiewicz.

The strong convexity of a function can be tested as follows.

Lemma 3. Let ƒ be twice continuously differentiable. Then ƒ is α-strongly convex if

$${υ}^{T} {∇}^{2} f ( x ) υ \geq α {‖ υ ‖}^{2} , \qquad ( A 5 )$$

$$∀ x , υ ∈ {ℝ}^{m} .$$

Besides convexity, we also need to characterize the smoothness of a function.

Definition 5 (L-smoothness). Let ƒ: [symbol] ^{m}→ [symbol] and L>0. We say that ƒ is L-smooth if it is differentiable and if the gradient ∇ƒ is L-Lipschitz:

$$‖ ∇ f ( x ) - ∇ f ( y ) ‖ \leq L ‖ x - y ‖ , \qquad ( A 6 )$$

$$∀ x , y ∈ {ℝ}^{m} .$$

For L-smooth functions we have the following useful property (see Garrigos).

Lemma 4 (Descent lemma). Let ƒ: [symbol] ^{m}→ [symbol] be a twice differentiable, L-smooth function, then

$$f ( y ) \leq f ( x ) + ∇ {f ( x )}^{T} ( y - x ) + \frac{L}{2} {‖ y - x ‖}^{2} . \qquad ( A 7 )$$

### 2. Derivative of a Matrix Exponential

The derivative of the matrix exponential e^{H} with respect to a parameter is given by Duhamel's formula

$${\partial }_{θ} {e}^{H} = {\int }_{0}^{1} {e}^{( 1 - s ) H} ( {\partial }_{θ} H ) {e}^{s H} ds . \qquad ( A 8 )$$

Taking H=W+θV, with simple manipulations we find a useful alternative expression

$$\begin{matrix}{\partial }_{θ} {e}^{H} = {e}^{H} {\int }_{0}^{1} {e}^{- sH} V {e}^{sH} ds \\ = {\sum }_{j , k} \vert j k \vert j \vert V \vert k {e}^{{λ}_{j}} {\int }_{0}^{1} {e}^{s ( {λ}_{k} - {λ}_{j} )} ds \\ = {\sum }_{j , k} \vert k \vert {V}_{j , k} {e}^{{λ}_{j}} \frac{{e}^{{λ}_{k} - {λ}_{j}} - 1}{{λ}_{k} - {λ}_{j}} .\end{matrix} \qquad ( A 9 )$$

Here we use the basis diagonalizing the Hamiltonian, H=Σⱼλⱼ| [symbol] [symbol] j|, and we introduce the notation Vⱼₖ= [symbol] j|V|k [symbol] The above expression is valid also for the diagonal entries, k=j, since

$${lim}_{x \to 0} \frac{{e}^{x} - 1}{x} = 1 .$$

### Now,

$${e}^{{λ}_{j}} \frac{{e}^{{λ}_{k} - {λ}_{j}} - 1}{{λ}_{k} - {λ}_{j}} = \text{} {e}^{{λ}_{j}} \frac{{e}^{{λ}_{k} - {λ}_{j}} - 1}{{e}^{{λ}_{k} - {λ}_{j}} + 1} \frac{{e}^{{λ}_{k} - {λ}_{j}} + 1}{{λ}_{k} - {λ}_{j}} = \frac{tanh ( \frac{{λ}_{k} - {λ}_{j}}{2} )}{\frac{{λ}_{k} - {λ}_{j}}{2}} \frac{{e}^{{λ}_{k}} + {e}^{{λ}_{j}}}{2} . \qquad ( A10 )$$

With the notation

$$\hat{f} ( ω ) = \frac{tanh ( \frac{ω}{2} )}{\frac{ω}{2}}$$

we can write

$${\partial }_{θ} {e}^{H} = {\sum }_{j , k} \vert j k \vert {V}_{jk} \hat{f} ( {λ}_{k} - {λ}_{j} ) \frac{1}{2} ( {e}^{{λ}_{k}} + {e}^{{λ}_{j}} ) . \qquad ( A11 )$$

Let us interpret \hat{ƒ}(ω) as the Fourier transform of another function: \hat{ƒ}(ω)=∫_{-∞}^{∞}ƒ(t)e^{-itω}dt. Plugging this in the previous expression we obtain

$$\begin{matrix}{\partial }_{θ} {e}^{H} = {\sum }_{j , k} \vert j k \vert {V}_{jk} {\int }_{- ∞}^{∞} f ( t ) {e}^{- it ( {λ}_{k} - {λ}_{j} )} dt ( \frac{{e}^{{λ}_{k}}}{2} + \frac{{e}^{{λ}_{j}}}{2} ) \\ = \frac{1}{2} {\int }_{- ∞}^{∞} f ( t ) {\sum }_{j} {e}^{it {λ}_{j}} \vert j j \vert V {\sum }_{k} {e}^{- it {λ}_{k} + {λ}_{k}} \vert k k \vert dt + \\ \frac{1}{2} {\int }_{- ∞}^{∞} f ( t ) {\sum }_{j} {e}^{it {λ}_{j}} \vert j j \vert V {\sum }_{k} {e}^{- it {λ}_{k}} \vert k k \vert dt\end{matrix} \qquad ( A12 )$$

$$\begin{matrix}= \frac{1}{2} {\int }_{- ∞}^{∞} f ( t ) {e}^{itH} {Ve}^{- itH} {dte}^{H} + \frac{1}{2} {e}^{H} {\int }_{- ∞}^{∞} f ( t ) {e}^{itH} {Ve}^{- itH} dt \\ = \frac{1}{2} \{ Φ ( V ) , {e}^{H} \} .\end{matrix}$$

Here {A, B}=AB+BA is the anti-commutator, and we have defined ΦV)=∫_{-∞}^{∞}ƒ(t)e^{itH}Ve^{-itH}dt.

We have recovered, by different means, a result that is achievable via the method described in Hastings, “Quantum belief propagation: An algorithm for thermal quantum systems”, Phys. Rev. B 76, 201102 (2007).

### Appendix B: Properties of the Quantum Relative Entropy for Quantum Boltzmann Machines

Set out below is a proof of some properties of the quantum relative entropy S(η∥ρ_{θ}) of a generic QBM ρ_{θ} with respect to some arbitrary target η. These properties are used for the proof of the theorems in the main text. We start by showing the convexity and afterward we show the L-smoothness.

### 1. Strict Convexity

In order to show (strict) convexity of S, we can use Lemma 1 above. We first show that the Hessian of the quantum relative entropy with respect to the QBM parameters, ∇²S, is positive semidefinite. Afterwards, we show that S has only one unique global optimizer θ* for which ∇S(η∥ρ_{θ*})=0, and apply the Lemma.

We recall from the main text that the QBM Hamiltonian, [symbol] _{θ}=ΣᵢθᵢHᵢ, is a sum over Hermitian, in general non-commuting, operators Hᵢ. Using the derivative of the matrix exponential in Equation (A12), we have:

$$\begin{matrix}\frac{\partial S}{\partial {θ}_{i}} = \frac{\partial }{\partial {θ}_{i}} Tr [ η ( log η - {ℋ}_{θ} + log Tr [ {e}^{{ℋ}_{θ}} ] ) ] \\ = - Tr [ η {H}_{i} ] + \frac{T r [ \{ Φ ( {H}_{i} ) , {e}^{{ℋ}_{θ}} \} ]}{2 T r [ {e}^{{ℋ}_{θ}} ]} \\ = - Tr [ η {H}_{i} ] + T r [ {ρ}_{θ} Φ ( {H}_{i} ) ]\end{matrix} \qquad ( B1 )$$

$$= - Tr [ η {H}_{i} ] + T r [ {ρ}_{θ} {H}_{i} ] . ( B 1 )$$

In the last step we use the cyclic property of the trace. This is Equation (4) in the main text that precedes the appendix. We now take the second derivative starting from Equation (B1):

$$\begin{matrix}\frac{{\partial }^{2} s}{\partial {θ}_{i} \partial {θ}_{j}} = \frac{\partial }{\partial {θ}_{j}} Tr [ {ρ}_{θ} Φ ( {H}_{i} ) ] \\ = Tr [ ( \frac{\{ Φ ( {H}_{j} ) , {e}^{{ℋ}_{θ}} \}}{2 T r [ {e}^{{ℋ}_{θ}} ]} - \frac{{e}^{{ℋ}_{θ}} T r [ \{ Φ ( {H}_{j} ) , {e}^{{ℋ}_{θ}} \} ]}{2 {( T r [ {e}^{{ℋ}_{θ}} ] )}^{2}} ) Φ ( {H}_{i} ) ] \\ = \frac{1}{2} Tr [ {ρ}_{θ} \{ Φ ( {H}_{i} ) , Φ ( {H}_{j} ) \} ] - T r [ {ρ}_{θ} Φ ( {H}_{i} ) ] T r [ {ρ}_{θ} Φ ( {H}_{j} ) ] .\end{matrix} \qquad ( B2 )$$

In the last step we used Tr[A{B, C}]=Tr[C{A, B}] to rearrange the terms.

As Φ(V) is a Hermitian operator for any Hermitian V we see that the Hessian has the form of a covariance matrix.

It is then readily shown to be positive semidefinite and satisfies Equation (A2). For any vector v∈

$$\begin{matrix}{v}^{T} {∇}^{2} Sv = {\sum }_{n , m} {v}_{n} {v}_{m} ( \frac{1}{2} T r [ {ρ}_{θ} \{ Φ ( {H}_{n} ) , Φ ( {H}_{m} ) \} ] - \\ Tr [ {ρ}_{θ} Φ ( {H}_{n} ) ] T r [ {ρ}_{θ} Φ ( {H}_{m} ) ] ) \\ = \frac{1}{2} T r [ {ρ}_{θ} \{ {\sum }_{n} {v}_{n} Φ ( {H}_{n} ) , {\sum }_{m} {v}_{m} Φ ( {H}_{m} ) \} ] -\end{matrix} \qquad ( B3 )$$

$$\begin{matrix}Tr [ {ρ}_{θ} {\sum }_{n} {v}_{n} Φ ( {H}_{n} ) ] T r [ {ρ}_{θ} {\sum }_{m} {v}_{m} Φ ( {H}_{m} ) ] \\ = \frac{1}{2} T r [ {ρ}_{θ} \{ Φ ( W ) , Φ ( W ) \} ] - T r [ {ρ}_{θ} Φ ( W ) ] T r [ {ρ}_{θ} Φ ( W ) ] \\ = Tr [ {ρ}_{θ} {Φ ( W )}^{2} ] - T {r [ {ρ}_{θ} Φ ( W ) ]}^{2}\end{matrix}$$

$$\begin{matrix}= Tr [ {{ρ}_{θ} ( Φ ( W ) - T r [ {ρ}_{θ} Φ ( W ) ] I )}^{2} ] \\ = \geq 0.\end{matrix}$$

Here we define Hermitian operator W=ΣₙvₙHₙ. The last line is the expectation value of the square of a Hermitian operator, and as such it must be non-negative.

This means that the quantum relative entropy is convex. We now show strict convexity by a contradiction argument, following Proposition 17 in Anshu et al., “Sample-efficient learning of interacting quantum systems”, Nature Physics 17, 931 (2021) (hereinafter “Anshu”). Assume we have found one set of parameters θ* with ∇(η∥ρ_{θ*})=0. Then from Equation (B1) we have

[symbol]

Hᵢ [symbol] _{η}= [symbol] Hᵢ [symbol] _{ρ}_{_{θ*}}

for all Hᵢ. Note that we can always find at least one such θ* by Jaynes' [symbol] principle, see Jaynes, “Information Theory and Statistical Mechanics”, Phys. Rev. 106, 620 (1957). Next, assume there exists a different set of parameters, χ≠θ*, with [symbol] Hᵢ [symbol] _{η}= [symbol] Hᵢ [symbol] _{ρ}_{_{χ}} for all Hᵢ. Then

$$\begin{matrix}S ( {ρ}_{χ} ‖ {ρ}_{θ}^{*} ) = Tr [ {ρ}_{χ} log {ρ}_{χ} ] - T r [ {ρ}_{χ} log {ρ}_{{θ}^{*}} ] \\ = Tr [ {ρ}_{χ} log {ρ}_{χ} ] - {\sum }_{i} {θ}_{i}^{*} T r [ {ρ}_{χ} {H}_{i} ] + log {Z}_{{θ}^{*}} \\ = Tr [ {ρ}_{χ} log {ρ}_{χ} ] - {\sum }_{i} {θ}_{i}^{*} T r [ {ρ}_{θ} * {H}_{i} ] + log {Z}_{{θ}^{*}}\end{matrix} \qquad ( B4 )$$

$$\begin{matrix}= Tr [ {ρ}_{χ} log {ρ}_{χ} ] - T r [ {ρ}_{θ} * log {ρ}_{{θ}^{*}} ] \\ = \geq 0. ( B 4 )\end{matrix}$$

Similarly, by swapping ρ_{χ} and ρ_{θ*}, we find

$$S ( {ρ}_{{θ}^{*}} ‖ {ρ}_{χ} ) = T r [ {ρ}_{{θ}^{*}} log {ρ}_{{θ}^{*}} ] - T r [ {ρ}_{χ} log {ρ}_{χ} ] \geq 0. \qquad ( B5 )$$

It follows that S(ρ_{θ*}∥ρ_{χ})=0, implying ρ_{θ*}=ρ_{χ}. Now because the operators Hᵢ are orthogonal we have θ*=χ. This contradicts the assumption in the beginning (θ*≠χ), and we can have only one unique θ* with ∇S(η∥ρ_{θ*})=0. Hence S is strictly convex by Definition 2.

### 2. Strong Convexity

To show α-strong convexity of S one can use Lemma 3. To the best of our knowledge there is no proof in the literature showing that quantum relative entropy of Gibbs states is strongly convex in general. On the other hand, this property has been proven for particular classes of Hamiltonians. Anshu et al. prove strong convexity for k-local Hamiltonians defined on a finite dimensional lattice. They show that in this case

$$α ∈ O ( \frac{1}{n} ) ,$$

a polynomial decrease with respect to the system size. Strong convexity for the more general class of low-intersection Hamiltonians was proved in Haah et al., “Optimal learning of quantum Hamiltonians from high temperature Gibbs states”, IEEE 63rd Annual Symposium on Foundations of Computer Science (FOCS), pp. 135-146 (2022) (hereinafter “Haah”). Low-intersection Hamiltonians have terms that act non-trivially only on a constant number of qubits, and each term intersects non-trivially with a constant number of other terms.

In this section, we use differentiable programming to numerically analyze the smallest eigenvalue of the Hessian, λₘᵢₙ(∇²S), seeking evidence for strong convexity; see Baydin et al., “Automatic differentiation in machine learning: A survey”, arXiv:1502.05767 (2018). We consider a 1D nearest-neighbor Hamiltonian:

$$ℋ = {\sum }_{i = 1}^{n - 1} {h}_{i , i + 1}^{xx} {X}_{i} {X}_{i + 1} + {h}_{i , i + 1}^{yy} {Y}_{i} {Y}_{i + 1} + {h}_{i , i + 1}^{zz} {Z}_{i} {Z}_{i + 1} ;$$

and a fully-connected one:

$$ℋ = {\sum }_{i = 1}^{n - 1} {\sum }_{j > i}^{n} {h}_{i , j}^{xx} {X}_{i} {X}_{j} + {h}_{i , j}^{yy} {Y}_{i} {Y}_{j} + {h}_{i , j}^{zz} {Z}_{i} {Z}_{j} .$$

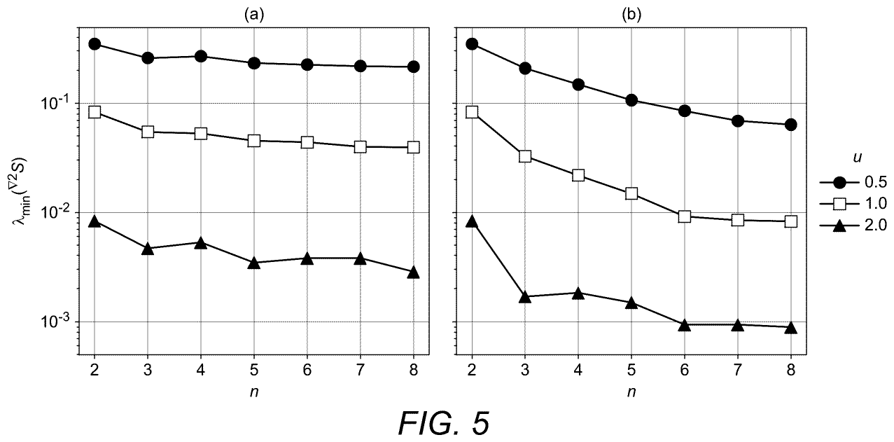

We randomly sample coefficients uniformly in [−μ,μ] where μ is a scale parameter and determines the maximum size of random parameters of the vector of the coefficients. FIG. 5 shows the minimum eigenvalue (y-axis) of the Hessian, as a function of the number of qubits, n (x-axis), showing the median of 25 random instances for (a) the 1D nearest neighbour Hamiltonian and (b) a fully-connected Hamiltonian. The scale parameter p determines the maximum size of random parameters. In all cases, the smallest eigenvalue decreases with increasing the number of qubits, but appears to converge to a positive value (plateau) for larger values of n (especially in the case of the fully-connected Hamiltonian (b)). The fully-connected Hamiltonian has m∈O(n²) parameters and yields smaller eigenvalues than the 1D Hamiltonian which has m∈O(n) parameters instead. These results provide evidence of strong convexity with a decreasing polynomially with the system size.

### 3. L-Smoothness

We show that the quantum relative entropy S(η∥ρ_{θ}) is an L-smooth function of θ. To do so we need an upper bound on the largest eigenvalue of the Hessian in Equation B2. We begin with the following property:

$$‖ Φ ( V ) ‖ = ‖ {\sum }_{j , k} \vert j 〉 〈 k \vert {V}_{j k} \hat{f} ( {λ}_{k} - {λ}_{j} ) ‖ \leq \vert {\hat{f}}_{max} \vert ‖ {\sum }_{j , k} \vert j 〉 〈 k \vert {V}_{j k} ‖ = ‖ V ‖ , \qquad ( B6 )$$

where we use that \hat{ƒ}>0 and \hat{ƒ}ₘₐₓ=1. In what follows we use the above result with ∥⋅∥₂, the operator norm induced by the Euclidean vector norm (p=2). Let us bound the entries of the Hessian

$${\vert \frac{{\partial }^{2} S}{\partial {θ}_{j} \partial {θ}_{k}} \vert = \vert \frac{1}{2} T r [ {ρ}_{θ} \{ Φ ( {H}_{j} ) , Φ ( {H}_{k} ) \} ] - T r [ {ρ}_{θ} Φ ( {H}_{j} ) ] T r [ {ρ}_{θ} Φ ( {H}_{k} ) ] \vert \leq \frac{1}{2} \vert {λ}_{max} ( \{ Φ ( {H}_{j} ) , Φ ( {H}_{k} ) \} ) \vert + \vert {λ}_{max} ( Φ ( {H}_{j} ) ) \vert \vert {λ}_{max} ( Φ ( {H}_{k} ) ) \vert \leq \frac{1}{2} {‖ \{ Φ ( {H}_{j} ) , Φ ( {H}_{k} ) \} ‖}_{2} + {‖ Φ ( {H}_{j} ) ‖}_{2} {‖ Φ ( {H}_{k} ) ‖}_{2} \leq 2 \vert Φ ( {H}_{j} ) ‖}_{2} {‖ Φ ( {H}_{k} ) ‖}_{2} \leq 2 {‖ {H}_{j} ‖}_{2} {‖ {H}_{k} ‖}_{2} . \qquad ( B7 )$$

Here we use that expectations are bounded by the largest eigenvalue or, alternatively, by the p=2 operator norm. We also use the sub-multiplicative property of the operator norm, and Equation (B6) above. We are now able to put an upper-bound on the largest eigenvalue of the Hessian matrix:

$${‖ {∇}^{2} S ‖}_{2} = \vert {λ}_{max} ( {∇}^{2} S ) \vert \leq {max}_{j} {\sum }_{k} \vert \frac{{\partial }^{2} S}{\partial {θ}_{j} \partial {θ}_{k}} \vert \leq m {max}_{j} {max}_{k} \vert \frac{{\partial }^{2} S}{\partial {θ}_{j} \partial {θ}_{k}} \vert \leq 2 m {max}_{j} {max}_{k} {‖ {H}_{j} ‖}_{2} {‖ {H}_{k} ‖}_{2} = 2 m {max}_{j} {‖ {H}_{j} ‖}_{2}^{2} \qquad ( B8 )$$

The first equality uses the fact that the Hessian is a symmetric matrix, the first inequality is a consequence of the Gershgorin circle theorem.

We can use this result to prove the L-smoothness.

Let us define a function h(t)=∇S(η∥ρ_{y+t(x-y)}). Then we have

$${‖ ∇ S ( η ‖ {ρ}_{x} ) - ∇ S ( η ‖ {ρ}_{y} ) ‖}_{2} = {‖ h ( 1 ) - h ( 0 ) ‖}_{2} = {‖ {\int }_{0}^{1} {h}^{′} ( t ) dt ‖}_{2} \leq {\int }_{0}^{1} {‖ {h}^{′} ( t ) ‖}_{2} dt = {\int }_{0}^{1} ‖ {∇}^{2} S ( η ‖ {ρ}_{y + t ( x - y )} ) ( x - y ) {‖}_{2} dt \leq {\int }_{0}^{1} ‖ {∇}^{2} S ( η ‖ {ρ}_{y + t ( x - y )} ) {‖}_{2} {‖ x - y ‖}_{2} dt \leq 2 m {max}_{n} {‖ {H}_{n} ‖}_{2}^{2} {‖ x - y ‖}_{2} \qquad ( B9 )$$

where in the last step we used Equation B8. Thus, the quantum relative entropy is L-smooth with L=2m maxⱼ∥Hⱼ∥₂².

### Appendix C: Convergence Results of Stochastic Gradient Descent for Training Quantum Boltzmann Machines

In this appendix we first review useful results from the machine learning literature, then prove Theorems 1 and 2 in the main text that precedes the appendix. We also discuss a few upper bounds for the relative entropy in the context of QBM learning.

### 1. Review of Stochastic Gradient Descent Convergence Results

We begin by stating three convergence results from the SGD literature. Consider a loss function ƒ: [symbol] ^{m}→ [symbol] that is L-smooth (Definition 5 and bounded from below by β_{inf}∈ [symbol] . The stochastic gradient is unbiased, i.e., [symbol] [ĝ]=∇ƒ, and satisfies

$$𝔼 {‖ \hat{g} ( x ) ‖}^{2} \leq 2 A ( f ( x ) - {f}_{inf} ) + B {‖ ∇ f ( x ) ‖}^{2} + C , \qquad ( C1 )$$

for some A, B, C≥0 and all x∈ [symbol] ^{m}. SGD iteratively minimizes ƒ according to the update rule x^{t}=x^{t-1}γ^{t}ĝₓ_{^{t-1}} at time step t. Khaled et al., “Better theory for SGD in the nonconvex world”, arXiv:2002.03329 (2020) (hereinafter “Khaled”), proved the following SGD convergence result.

Lemma 5 (restatement of Corollary 1 in Khaled). Choose precision ϵ>0 and step size

$$γ = min \{ \frac{1}{\sqrt{LAT}} , \frac{1}{L B} , \frac{ϵ}{2 L C} \} , and set {δ}_{0} = 𝔼 [ f ( {x}^{0} ) ] - {f}_{inf} . \qquad ( C2 ) ]$$

$$Then provided that$$

$$T \geq \frac{12 {δ}_{0} L}{{ϵ}^{2}} max \{ B , \frac{12 {δ}_{0} A}{{ϵ}^{2}} , \frac{2 C}{{ϵ}^{2}} \} ,$$

we have that SGD converges with

$${min}_{1 \leq t \leq T} 𝔼 ‖ ∇ f ( {x}^{t} ) ‖ \leq ϵ . \qquad ( C3 )$$

Here E[⋅] denotes the expectation with respect to x^{t}, which is a random variable due to the stochasticity in the gradient. Let us now consider a loss function which, in addition to the previous conditions, is also α-Polyak-Lojasiewicz (Definition 3). We consider the following iterative learning rate scheme for γₜ.

Lemma 6 (restatement of Lemma 3 in Khaled). Considera sequence (rₜ)ₜ satisfying

rₜ₊₁(1−αγₜ)rₜ+cγₜ²,

where γₜ≤1/b for all t≥0 and a,c≥0 with a≤b. Fix T>0 and let

$${k}_{0} = ⌈ \frac{T}{2} ⌉ .$$

Then choosing the step size as

$${γ}_{t} = \{ \begin{matrix}\frac{1}{b} , & if T \leq \frac{b}{a} or t < {k}_{0} , \\ \frac{2}{a ( s + t - {k}_{0} )} , & if T \geq \frac{b}{a} and t > {k}_{0} ,\end{matrix} \qquad ( C4 )$$

$$with s = \frac{2 b}{a} gives {r}_{T} \leq exp \{ - \frac{aK}{2 b} \} {r}_{0} + \frac{9 c}{{a}^{2} T}$$

For this learning rate scheme, Khaled et al. proved the following SGD convergence result.

Lemma 7 (restatement of Corollary 2 in Khaled). Choose precision ϵ>0 and step size γₜ following Lemma 6 with

$${γ}_{t} \leq min \{ \frac{α}{2 A L} , \frac{1}{2 B L} \} .$$

Then provided that

$$T \geq \frac{L}{α} max \{ \frac{2 A}{α} log \frac{2 {δ}_{0}}{ϵ} , \frac{2 B}{α} log \frac{2 {δ}_{0}}{ϵ} , \frac{9 C}{2 αϵ} \} \qquad ( C5 )$$

we have that SGD converges with

$$𝔼 \vert f ( {x}^{T} ) - {f}_{inf} \vert \leq ϵ . \qquad ( C6 )$$

### 2. Proofs of Theorems 1 and 2 in the Main Text

We prove Theorem 1, which is repeated here for completeness.

Theorem 1 (QBM training). Given a QBM defined by a set of n-qubit Pauli operators {Hᵢ}ᵢ₌₁^{m}, a precision κ for the QBM expectations, a precision for the data expectations, and a target precision ϵ such that

$${κ}^{2} + {ξ}^{2} \geq \frac{ε}{2 m}$$

### After

$$T \geq \frac{48 {δ}_{0} {m}^{2} ( {κ}^{2} + {ξ}^{2} )}{{ϵ}^{4}} \qquad ( C7 )$$

iterations of stochastic gradient descent on the relative entropy S(η∥ρ_{θ}) with constant learning rate

$${γ}^{t} = \frac{ϵ}{4 {m}^{2} ( {κ}^{2} + {ξ}^{2} )} ,$$

we have

$${min}_{t = 1 , … , T} 𝔼 \vert {〈 {H}_{i} 〉}_{{ρ}_{{θ}^{t}}} - {〈 {H}_{i} 〉}_{η} \vert \leq ϵ , ∀ i , \qquad ( C8 )$$

where [symbol] [⋅] denotes the expectation with respect to the random variable t. Each iteration t∈{0, . . . , T} requires

$$𝒩 \geq 𝒪 ( \frac{1}{{κ}^{4}} log \frac{m}{1 - {λ}^{\frac{1}{T}}} ) \qquad ( C9 )$$

preparations of the Gibbs state ρ_{θ}_{^{t}}, and the success probability of the full algorithm is λ. Here, δ₀=S(η∥ρ_{θ}_{⁰})−S(η∥ρ_{θ}_{^{opt}}) is the relative entropy difference with the optimal model ρ_{θ}_{^{opt}}.

Proof. The quantum relative entropy is L-smooth with L=2m maxᵢ∥Hᵢ∥₂², and for Pauli operators ∥Hᵢ∥₂=1. Then, we can minimize the relative entropy by SGD and apply the convergence result in Lemma 5.

For the SGD algorithm we need an unbiased gradient estimator with bounded variance. We recall that the gradient of the relative entropy is given by ∂_{θ}_{ᵢ}S(η∥ρ_{θ})= [symbol] Hᵢ [symbol] _{ρ}_{_{θ}}− [symbol] Hᵢ [symbol] _{θ}. The target expectation values [symbol] Hᵢ [symbol] _{θ} are estimated as from the data set, as described in Appendix E below. Note that | [symbol] Hᵢ [symbol] _{θ}−ĥ_{i,θ}|≤ξ, where ξ>0 is limited by the size of the data set. One can improve on by collecting more data, as long as the amount of samples is polynomial in n.

For estimating the QBM expectation values [symbol] Hᵢ [symbol] _{ρ}_{_{θ}}, we can use a number of techniques. Here we focus on classical shadow tomography. As is known from Theorem 4 in Huang et al., “Information-theoretic bounds on quantum advantage in machine learning”, Phys. Rev. Lett. 126, 190505 (2021), for example, there exists a procedure that returns the expectation values of m different Pauli operators {Hᵢ} to precision κ with

$$𝒪 ( \frac{log ( m / \tilde{λ )}}{{κ}^{4}} )$$

preparations of ρ_{θ}¹. The success probability of the procedure is 1−\tilde{λ}. Thus, we can obtain estimators ĥ_{i,ρ}_{_{θ}} such that

$${max}_{i} \vert {\hat{h}}_{i , {ρ}_{θ}} - {〈 {H}_{i} 〉}_{{ρ}_{θ}} \vert \leq κ . \qquad ( C10 )$$

We then use ĝ_{θ}_{ᵢ}=ĥ_{i,ρ}_{_{θ}}−ĥ_{i,η} as estimators for the partial derivatives of the quantum relative entropy. The variance of the norm of the gradient estimator is bounded as ¹ Note that this procedure only applies to Pauli operators so from now on we define the Hᵢ in the QBM Hamiltonian to be Pauli operators. We discuss in the main text that this result can be generalized to other types of operators resorting to other shadow tomography protocols.

$$\begin{matrix}𝔼 {‖ {\hat{g}}_{θ} - ∇ S ( η ‖ {ρ}_{θ} ) ‖}^{2} = 𝔼 {\sum }_{i = 1}^{m} {( {\hat{h}}_{i , {ρ}_{θ}} - {\hat{h}}_{i , η} - {〈 {H}_{i} 〉}_{{ρ}_{θ}} + {〈 {H}_{i} 〉}_{η} )}^{2} \\ \leq 𝔼 {\sum }_{i = 1}^{m} {( {\hat{h}}_{i , {ρ}_{θ}} - {〈 {H}_{i} 〉}_{{ρ}_{θ}} )}^{2} + {( {\hat{h}}_{i , η} - {〈 {H}_{i} 〉}_{η} )}^{2} \\ \leq m ( {κ}^{2} + {ξ}^{2} )\end{matrix} . \qquad ( C11 )$$

Since the variance can also be written as [symbol] ∥ĝ_{θ}∥²−∥∇S∥(η∥ρ_{θ})∥² we find that our setup is compatible with Equation (C5) for A=0, B=1, C=m(κ²+ξ²). We choose

$$ϵ < 1 and {κ}^{2} + {ξ}^{2} \geq \frac{ϵ}{2 m}$$

in Lemma 5. This yields a learning rate of

$$γ = \frac{ϵ}{4 {m}^{2} ( {κ}^{2} + {ξ}^{2} )} .$$

We conclude that after

$$T \geq \frac{48 {δ}_{0} {m}^{2} ( {κ}^{2} + {ξ}^{2} )}{{ϵ}^{4}} \qquad ( C12 )$$

iterations of SGD we have

$${min}_{1 \leq t \leq T} 𝔼 ‖ ∇ S ( η ‖ {ρ}_{{θ}^{t}} ) ‖ \leq ϵ . \qquad ( C13 )$$

Here δ₀=S(η∥ρ_{θ}_{⁰})−S(η∥ρ_{θ}_{^{opt}}) is the relative entropy at the initialization minus the relative entropy at the optimum. Importantly we note the QBM expectation values are computed with a success probability 1−\tilde{λ} at each iteration. Consequently, the total success probability of the whole training is equal to (1−\tilde{λ})^{T} for T update steps. Then to have a total success probability of λ we need to set

$$\tilde{λ} = ( 1 - {λ}^{\frac{1}{T}} )$$

in the shadow tomography protocol. This result, together with the sampling bound on the number of measurements of the shadow tomography

$$𝒪 ( \frac{log ( m / \tilde{λ )}}{{κ}^{4}} ) ,$$

completes the proof of Theorem 1.

We now provide a proof for Theorem 2, which we restate here.

Theorem 2 (α-strongly convex QBM training). Given a QBM defined by a Hamiltonian ansatz [symbol] _{θ} such that S(η∥ρ_{θ}) is α-strongly convex, a precision κ for the QBM expectations, a precision ξ for the data expectations, and a target precision ϵ such that

$${κ}^{2} + {ξ}^{2} \geq \frac{ε}{{2}_{m}} .$$

### After

$$T \geq \frac{18 {m}^{2} ( {κ}^{2} + {ξ}^{2} )}{{α}^{2} {ε}^{2}} \qquad ( C 14 )$$

iterations of stochastic gradient descent on the relative entropy S(η∥ρ_{θ}) with learning rate

$${γ}^{t} \leq \frac{1}{4 {m}^{2}}$$

(see Appendix C.2 for the specific learning rate schedule), we have

$$\begin{matrix}{min}_{t = 1 … . T} 𝔼 \vert {H}_{i} {{ρ}_{At}}_{} - {H}_{i} {η}_{} \vert \leq ϵ , & ∀ i .\end{matrix} \qquad ( C 15 )$$

Each iteration requires the number of samples given in Equation (C9).

In order to prove this theorem, we first show that η, ρ^{opt} and ρ_{θ} are ‘collinear’ with respect to the relative entropy.

$$\begin{matrix}S ( η ‖ {ρ}_{θ} ) - S ( η ‖ {ρ}_{{θ}^{opt}} ) = - Tr [ η log {ρ}_{θ} ] + T r [ η log {ρ}_{{θ}^{opt}} ] \\ = - Tr [ η {ℋ}_{θ} ] + log {Z}_{θ} + [ η {ℋ}_{{θ}^{o p t}} ] - log {Z}_{{θ}^{opt}} \\ = - Tr [ {ρ}_{{θ}^{o p t}} {ℋ}_{θ} ] + log {Z}_{θ} + [ {ρ}_{{θ}^{o p t}} {ℋ}_{{θ}^{o p t}} ] - log {Z}_{{θ}^{opt}} \\ = - Tr [ {ρ}_{{θ}^{opt}} log {ρ}_{θ} ] + T r [ {ρ}_{{θ}^{opt}} log {ρ}_{{θ}^{opt}} ] \\ = S ( {ρ}_{{θ}^{opt}} ‖ {ρ}_{θ} ) .\end{matrix} \qquad ( C 16 )$$

Here, in the going from the second to the third line, we used the fact that Tr[ηHᵢ]=Tr[ρ_{θ}_{^{opt}}Hᵢ], which follows from setting Equation (B1) to zero. Rearranging the terms we get the collinearity S(η∥ρ_{θ})=S(η∥ρ_{θ}_{^{opt}})+S(ρ_{θ}_{^{opt}}∥ρ_{θ}). This is a non-trivial result because the relative entropy is not a distance: it is not symmetric and does not satisfy the triangle inequality in general. With this relation we are now able to prove Theorem 2.

Proof. S(ρ_{θ}_{^{opt}}∥ρ_{θ}) satisfies all the relevant assumptions for SGD convergence: it is L-smooth function with L=2m maxᵢ∥Hᵢ∥₂², it is bounded below by 0, and the stochastic gradient has bounded variance [Equations (C11) and (C9) apply]. Recall that we use Pauli terms in the Hamiltonian, so that ∥Hᵢ∥₂=1 and L=2m.

In addition, the α-strong convexity assumed by the theorem implies that S(ρ_{θ}_{^{opt}}∥ρ_{θ}) is α-Polyak-Lojasiewicz by Lemma 2. This means we can invoke Lemma 7. As before, we set A=0, B=1, C=m(κ²+ξ²) and choose ϵ′<1 in the Lemma, thus obtaining a maximum learning rate

$${γ}_{t} \leq \frac{1}{4 {m}^{2}} .$$

Looking at the case² where

$$\frac{2}{α} log \frac{2 {δ}_{0}}{{ϵ}^{′}} \leq \frac{9 m ( {κ}^{2} + {ξ}^{2} )}{2 {αϵ}^{′}} ,$$

we find that after

$$T \geq \frac{9 {m}^{2} ( {κ}^{2} + {ξ}^{2} )}{{α}^{2} {ϵ}^{′}}$$

iterations the expected relative entropy is [symbol] S(ρ_{θ}_{^{opt}}∥ρ_{θ}_{^{T}})≤ϵ′. It follows that

$$\begin{matrix}𝔼S ( {ρ}_{{θ}^{opt}} ‖ {ρ}_{{θ}^{T}} ) & \geq \frac{l}{2 ln 2} 𝔼 ‖ {ρ}_{{θ}^{opt}} - {ρ}_{{θ}^{T}} {‖}_{1}^{2}\end{matrix} \qquad ( C 17 )$$

$$\geq \frac{1}{2} {( 𝔼 ‖ {ρ}_{{θ}^{opt}} - {ρ}_{{θ}^{T}} )}^{2}$$

$$= \frac{1}{2} {( 𝔼 {max}_{- I < U \leq I} \vert Tr [ U ( {ρ}_{{θ}^{opt}} - {ρ}_{{θ}^{T}} ) )}^{2}$$

where we apply Pinsker's inequality in the first step, and we use the variational definition of trace distance in the last step. The maximization is over unitary matrices. Let us now consider unitary matrices defined as

$${U}_{i} = \frac{{H}_{i}}{‖ {H}_{i} ‖} + \sqrt[i]{I - \frac{{H}_{i}^{2}}{‖ {H}_{i} {‖}^{2}}} .$$

These have the property that

$${H}_{i} = ‖ {H}_{i} ‖ \frac{( {U}_{i} + {U}_{i}^{†} )}{2} .$$

### Therefore,

$$\begin{matrix}\sqrt{2 𝔼S ( {ρ}_{{θ}^{opt}} ‖ {ρ}_{{θ}^{T}} )} \geq 𝔼 {max}_{- I < U \leq I} \vert Tr [ \frac{1}{2} ( U + {U}^{†} ) ( {ρ}_{{θ}^{opt}} - {ρ}_{{θ}^{T}} ) ] \vert \\ \geq 𝔼 {{max}_{i}}_{} \vert Tr [ \frac{1}{2} ( {U}_{i} + {U}_{i}^{†} ) ( {ρ}_{{θ}^{opt}} - {ρ}_{{θ}^{T}} ) ] \vert \\ \geq 𝔼 {{max}_{i}}_{} \frac{1}{‖ {H}_{i} ‖} \vert Tr [ {H}_{i} {ρ}_{{θ}^{opt}} ] - T r [ {H}_{i} {ρ}_{{θ}^{T}} ] \vert .\end{matrix} \qquad ( C 18 )$$

Thus, we obtain ² Note that, depending on the problem specific parameter δ₀, and the free parameters κ and ξ, one could be in the other case of Lemma 7. One then follows the same steps shown here, and arrives at a slightly different, yet polynomial in n, number of steps.

$$\begin{matrix}\sqrt{2 {ϵ}^{′}} \geq \frac{1}{‖ {H}_{i} ‖} 𝔼 \vert Tr [ {H}_{i} {ρ}_{{θ}^{opt}} ] - T r [ {H}_{i} {ρ}_{{θ}^{T}} ] \vert , & ∀ i .\end{matrix} \qquad ( C 19 )$$

Since ∥Hᵢ∥=1 for Pauli operators. To solve the QBM learning to precision ϵ we choose

$${ϵ}^{′} = \frac{{ϵ}^{2}}{2}$$

and conclude that

$$\begin{matrix}𝔼 \vert Tr [ {H}_{i} {ρ}_{η} ] - T r [ {H}_{i} {ρ}_{{θ}^{T}} ] \vert \leq ϵ , & ∀ i .\end{matrix} \qquad ( C 20 )$$

### 3. Achieving a Desired Precision on the Quantum Relative Entropy for Theorem 1

In this section we study the scenario where the user is interested in obtaining a certain precision on the quantum relative entropy, rather than on the difference in the expectation values. Again, due to a potential model mismatch, we discuss the relative entropy S(ρ_{θ}_{^{opt}}∥ρ_{θ}) w.r.t. the optimal QBM ρ_{θ}_{^{opt}}.

We begin by training the QBM ρ_{θ} with SGD. Using Theorem 1, we can achieve | [symbol] Hᵢ [symbol] _{η}− [symbol] Hᵢ [symbol] _{ρ}_{_{θ}}|≤ϵ for all i with polynomial sampling complexity. This for same item implies a similar relation w.r.t. the optimal model: | [symbol] Hᵢ [symbol] _{η}− [symbol] Hᵢ [symbol] _{ρ}_{_{θ}}ₒₚₜ|≤ϵ. By the triangle inequality we have that | [symbol] Hᵢ [symbol] _{ρθ}− [symbol] Hᵢ [symbol] _{ρ}_{_{θ}}ₒₚₜ|≤2ϵ. Then

$$\begin{matrix}S ( {ρ}_{{θ}^{opt}} ‖ {ρ}_{θ} ) = Tr [ {ρ}_{{θ}^{opt}} log {ρ}_{{θ}^{opt}} ] - {\sum }_{i} {θ}_{i} Tr [ {ρ}_{{θ}^{opt}} {H}_{i} ] + log {Z}_{θ} \\ = Tr [ {ρ}_{{θ}^{opt}} log {ρ}_{{θ}^{opt}} ] - {\sum }_{i} {θ}_{i} Tr [ {ρ}_{{θ}^{opt}} {H}_{i} ] + log {Z}_{θ} + \\ {\sum }_{i} {θ}_{i} Tr [ {ρ}_{θ} {H}_{i} ] - {\sum }_{i} {θ}_{i} Tr [ {ρ}_{θ} {H}_{i} ] \\ = Tr [ {ρ}_{{θ}^{opt}} log {ρ}_{{θ}^{opt}} ] - Tr [ {ρ}_{θ} log {ρ}_{θ} ] + \\ {\sum }_{i} {θ}_{i} ( Tr [ {ρ}_{θ} {H}_{i} ] - Tr [ {ρ}_{{θ}^{opt}} {H}_{i} ] )\end{matrix} . \qquad ( C21 )$$

Similarly,

$$S ( {ρ}_{θ} ‖ {ρ}_{{θ}^{opt}} ) = - Tr [ {ρ}_{{θ}^{opt}} log {ρ}_{{θ}^{opt}} ] + Tr [ {ρ}_{θ} log {ρ}_{θ} ] - {\sum }_{i} {θ}_{i}^{opt} ( Tr [ {ρ}_{θ} {h}_{i} ] - Tr [ {ρ}_{{θ}^{opt}} {H}_{i} ] ) . \qquad ( C22 )$$

Thus

$$\begin{matrix}S ( {ρ}_{{θ}^{opt}} ‖ {ρ}_{θ} ) \leq S ( {ρ}_{{θ}^{opt}} ‖ {ρ}_{θ} ) + S ( {ρ}_{θ} ‖ {ρ}_{{θ}^{opt}} ) \\ = {\sum }_{i} ( Tr [ {ρ}_{θ} {H}_{i} ] - Tr [ {ρ}_{{θ}^{opt}} {H}_{i} ] ) ( {θ}_{i} - {θ}_{i}^{opt} ) \\ \leq {\sum }_{i} \vert Tr [ {ρ}_{θ} {H}_{i} ] - Tr [ {ρ}_{{θ}^{opt}} {H}_{i} ] \vert \cdot \vert {θ}_{i} - {θ}_{i}^{opt} \vert \\ \leq 2 ϵ {‖ θ - {θ}^{opt} ‖}_{1}\end{matrix} . \qquad ( C23 )$$

To minimize the quantum relative entropy to precision ϵ′, we choose

$$ϵ \leq \frac{{ϵ}^{′}}{2 {‖ θ - {θ}^{opt} ‖}_{1}} .$$

This determines the number of SGD iterations via Theorem 1. Note that the number of iterations remains polynomial in the system size n.

Finally we combine this result with Equation (C16) and obtain the implication

$$\vert {H}_{i} {η}_{} - {H}_{i} {{ρ}_{θ}}_{} \vert \leq ϵ , \\ ∀ i ⇒ S ( η ‖ {ρ}_{θ} ) - S ( η ‖ {ρ}_{{θ}^{opt}} ) = S ( {ρ}_{{θ}^{opt}} ‖ {ρ}_{θ} ) \leq 2 ϵ {‖ θ - {θ}^{opt} ‖}_{1} . \qquad ( C24 )$$

This proves Equation (6) in the main text.

### Appendix D: Pre-Training

In this appendix we first prove Theorem 3 in the main text, and then discuss various pre-training models.

### 1. Proof of Theorem Guaranteed Performance Improvement by Pre-Training

For completeness we start by restating Theorem from the main text.

Theorem 3 (QBM pre-training). Assume a target η and a QBM model ρ_{θ}=e^{Σ}^{ᵢ₌₁}^{^{m}}^{θ}^{ᵢ}^{H}^{ᵢ}/Z for which we like to minimize the relative entropy S(η∥ρ_{θ}). Initializing at θ⁰=0 and pre-training S(η∥ρ_{θ}) with respect to any subset of \tilde{m}≤m parameters guarantees that

$$S ( η ‖ {ρ}_{{θ}^{pre}} ) \leq S ( η ‖ {ρ}_{{θ}^{0}} ) , \qquad ( D1 )$$

where θ^{pre}=[χ^{pre},0_{m-\tilde{m}}] and the vector χ^{pre} of length i contains the parameters for the terms {Hᵢ}ᵢ₌₁^{\tilde{m}} at the end of pre-training. More precisely, starting from pₓ=eΣᵢ₌₁^{\tilde{m}}xᵢHᵢ/Z and minimizing S(η∥ρ_{χ}) with respect to χ ensures Equation (D1) for any S(η∥ρ_{χ}_{^{pre}})≤S(η∥ρ_{Ω}_{⁰}).

Proof. First we relate the difference in relative entropy between two parameter vectors in the full space to the difference in relative entropy of the pre-trained parameter space. In particular, for any real parameter vectors θ=[χ,0_{m-\tilde{m}}] and θ′=[χ′,0_{m-\tilde{m}}] we have

$$\begin{matrix}S ( η ‖ {ρ}_{θ} ) - S ( η ‖ {ρ}_{θ ′} ) = Tr [ η log {ρ}_{θ ′} ] - Tr [ η log {ρ}_{θ} ] \\ = {\sum }_{i = 1}^{m} ( {θ}_{i}^{′} - {θ}_{i} ) Tr [ η {H}_{i} ] - log Tr [ {e}^{{\sum }_{i = 1}^{m} {θ}_{i}^{′} {H}_{i}} ] + \\ log Tr [ {e}^{{\sum }_{i = 1}^{m} {θ}_{i} {H}_{i}} ] \\ = {\sum }_{i = 1}^{\tilde{m}} ( {χ}_{i}^{′} - {χ}_{i} ) Tr [ η {H}_{i} ] - log Tr [ {e}^{{\sum }_{i = 1}^{\tilde{m}} {χ}_{i}^{′} {H}_{i}} ] + \\ log Tr [ {e}^{{\sum }_{i = 1}^{\tilde{m}} {χ}_{i} {H}_{i}} ] \\ = Tr [ η log {ρ}_{{χ}^{′}} ] - Tr [ η log {ρ}_{χ} ] \\ = S ( η ‖ {ρ}_{χ} ) - S ( η ‖ {ρ}_{χ ′} )\end{matrix} \qquad ( D2 )$$

Now using pre-training vectors θ^{pre}=[χ^{pre},0_{m-\tilde{m}}] and θ⁰=[χ⁰,0_{m-\tilde{m}}]=0 we see that S(η∥ρ_{χ}_{^{pre}})≤S(η∥ρ_{χ}_{⁰}) implies S(η∥ρ_{θ}_{^{pre}})≤S(η∥ρ_{θ}_{⁰}). Thus, any method that finds such a χ^{pre} guarantees Equation (14).

While conclusive, the above proof does not provide us with a method to find such a χ^{pre}, i.e., it is agnostic to the specific pre-training method. As a constructive example, let us consider minimizing χ^{pre} with noiseless gradient decent on a subset of \tilde{m} parameters. This means we update the subset parameters as χ^{t}=χ^{t-1}−γ\tilde{∇}S(η\tilde{∥}ρ_{χ}_{^{t-1}}), where \tilde{∇}S(η∥ρ_{χ}_{^{t-1}}) is the gradient of the subset of parameters, and γ the learning rate. Since S is L-smooth, we can use the descent Lemma 4 to bound the difference in relative entropy of the subset

$$\begin{matrix}S ( η ‖ {ρ}_{{χ}^{t}} ) - S ( η ‖ {ρ}_{{χ}^{t - 1}} ) \leq ∇ {S ( η ‖ {ρ}_{{χ}^{t - 1}} )}^{T} ( - \tilde{γ} ∇ S ( η ‖ {ρ}_{{χ}^{t - 1}} ) ) + \\ \frac{L}{2} {‖ - \tilde{γ} ∇ S ( η ‖ {ρ}_{{χ}^{t - 1}} ) ‖}^{2} \\ = - γ ( 1 - \frac{γ L}{2} ) {‖ \tilde{∇} S ( η ‖ {ρ}_{{χ}^{t - 1}} ) ‖}^{2}\end{matrix} . \qquad ( D3 )$$

Setting

$$γ \leq \frac{2}{L}$$

we obtain S(η∥ρ_{χ}_{^{t}})≤S(η∥ρ_{χ}_{^{t-1}}). By recursively applying this inequality we obtain a λ^{pre} with

S(η∥ρ_{χ}_{^{pre}})≤S(η∥ρ_{χ}_{⁰}),

which by our theorem above ensures Equation (D1). Note that the smoothness L here is the smoothness on the subset of parameters, which can be bounded by L≤2\tilde{m} maxᵢ∥Hᵢ∥₂².

### 2. Pre-Training Methods

Here we discuss possible pre-training models and strategies to optimize them. We focus on the models discussed in the main text: 1) a mean-field model, 2) a Gaussian Fermionic model, 3) nearest-neighbor quantum spin models. The advantage of the first two models is that they can be trained analytically. While for the nearest-neighbor models this is not possible, they satisfy the locality assumptions in Anshu and Haah, and hence have a strongly convex relative entropy.

2a. Mean-field Quantum Boltzmann Machine

We define the mean-field QBM by the parameterized Hamiltonian

$${ℋ}_{θ} = {\sum }_{i}^{n} {θ}_{i}^{x} {σ}_{i}^{x} + {θ}_{i}^{y} {σ}_{i}^{y} + {θ}_{i}^{z} {σ}_{i}^{z} . \qquad ( D4 )$$

Since this Hamiltonian has a simple structure, in which many terms commute, we can find the optimal parameters analytically. First, recall that the QBM expectation values are given by

$${H}_{i} {{ρ}_{θ}}_{} = \frac{\partial }{\partial {θ}_{i}} log Tr [ {e}^{{ℋ}_{θ}} ] = \frac{\partial }{\partial {θ}_{i}} log {Z}_{θ} . \qquad ( D5 )$$

For the mean-field Hamiltonian, we find

$${Z}_{θ} = Tr [ {e}^{{\sum }_{i = 1}^{n} {θ}_{i}^{x} {σ}_{i}^{x} + {θ}_{i}^{y} {σ}_{i}^{y} + {θ}_{i}^{z} {σ}_{i}^{z}} ] = {\prod }_{i = 1}^{n} Tr [ {e}^{{θ}_{i}^{x} {σ}_{i}^{x} + {θ}_{i}^{y} {σ}_{i}^{y} + {θ}_{i}^{z} {σ}_{i}^{z}} ] = {\prod }_{i = 1}^{n} 2 cosh {‖ {θ}_{i} ‖}_{2} , \qquad ( D6 )$$

where we have defined ∥θᵢ∥₂=\sqrt{θᵢ^{x}^{²}+θᵢ^{y}^{²}+θᵢ^{z}^{²}}. Here we have used the commutativity of single qubit operators in the first equality, and expanded the exponent for the second equality. We therefore get

$$log {Z}_{θ} = {\sum }_{i = 1}^{n} log 2 cosh {‖ {θ}_{i} ‖}_{2} . \qquad ( D7 )$$

From which the derivative follows as

$$\frac{\partial }{\partial {θ}_{i}^{x , y , z}} log {Z}_{θ} = \frac{{θ}_{i}^{x , y , z}}{{‖ {θ}_{i} ‖}_{2}} tanh {‖ {θ}_{i} ‖}_{2} . \qquad ( D8 )$$

In order to find the optimal QBM parameters for each qubit, i, we then solve the three coupled equations,

$$\frac{{θ}_{i}^{x , y , z}}{{‖ {θ}_{i} ‖}_{2}} tanh {‖ {θ}_{i} ‖}_{2} = {σ}_{i}^{x , y , z} {η}_{} , \qquad ( D9 )$$

which corresponds to setting the QBM derivative in Equation (4) in the main text to zero. From the strict convexity of the relative entropy, we know this has one unique solution provided the target expectation values, [symbol] σᵢ^{x,y,z} [symbol] _{η} form a consistent set, i.e. it comes from a density matrix. We can find the solution by squaring the three equations, and adding them together, giving

$${‖ {θ}_{i} ‖}_{2} = tan {h}^{- 1} ( \sqrt{{σ}_{i}^{x} {η}_{2}^{} + {σ}_{i}^{y} {η}_{2}^{} + {σ}_{i}^{z} {η}_{2}^{}} ) . \qquad ( D10 )$$

Here we used that the argument of the tanh is always positive. Substituting this into Equation (D9) we then find the closed-form solution of the QBM parameters

$${θ}_{i}^{x , y , z} = {σ}_{i}^{x , y , z} {η}_{} \frac{tan {h}^{- 1} ( \sqrt{{〈 {σ}_{i}^{x} 〉}_{η}^{2} + {〈 {σ}_{i}^{y} 〉}_{η}^{2} + {〈 {σ}_{i}^{z} 〉}_{η}^{2}} )}{\sqrt{{〈 {σ}_{i}^{x} 〉}_{η}^{2} + {〈 {σ}_{i}^{y} 〉}_{η}^{2} + {〈 {σ}_{i}^{z} 〉}_{η}^{2}}} . \qquad ( D11 )$$

In practice, the optimal parameters for an arbitrary mean-field QBM can be obtained by numerically evaluating this expression for the given target expectation values.

2b. Gaussian Fermionic Quantum Boltzmann Machine

The Gaussian Fermionic QBM has a parameterized, quadratic, Fermionic Hamiltonian

$${ℋ}_{θ} = {\vec{C}}^{†} \tilde{Θ} \vec{C} ≡ {\sum }_{i , j} {\tilde{Θ}}_{ij} {\vec{C}}_{i}^{†} {\vec{C}}_{j} . \qquad ( D12 )$$

Here, \vec{C}^{†}=[c₁^{†}, . . . , c_{N}^{†}, c₁, . . . cₙ] is a vector containing n Fermionic mode creation and annihilation operators, which satisfy the Fermionic commutation relations {cᵢ,cⱼ^{†}}=δ_{i,j} and {cᵢ,cⱼ}=0. These Fermionic operators can be expressed as strings of Pauli operators by the Jordan-Wigner transformation. \tilde{Θ} is the 2n×2n dimensional matrix containing the QBM model parameters θ, which can be identified as a Fermionic single-particle Hamiltonian. Note that this matrix needs to be Hermitian, and since terms like c₁^{†}c₁^{†} are zero it has in total n² free parameters.

In order to find the optimal parameters, we use that the single-particle correlation matrix with entries [Γ_{ρθ}]ᵢⱼ [symbol] \vec{C}ᵢ^{†}\vec{C}ⱼ [symbol] _{ρ}_{_{θ}} contains sufficient information to compute all possible properties of the Gaussian quantum system. This includes all possible observables (via Wick's theorem), entanglement measures, and also sampling from ρ_{θ}; see Surace et al., “Fermionic Gaussian states: An introduction to numerical approaches”, SciPost Physics Lecture Notes (2022). In particular, the Gaussian Fermionic QBM gradient reduces to the difference in the correlation matrices of the target and the model

$$\frac{\partial S}{\partial {\tilde{Θ}}_{ij}} = {\vec{C}}_{i}^{†} {\vec{C}}_{j} {{ρ}_{θ}}_{} - {\vec{C}}_{i}^{†} \vec{{C}_{j}} {η}_{} . \qquad ( D13 )$$

We can solve this by first determining the target expectation values [symbol] \vec{C}ᵢ^{†}\vec{C}ⱼ [symbol] _{η} and setting [symbol] \vec{C}ᵢ^{†}\vec{C}ⱼ [symbol] _{ρ}_{_{θ*}}= [symbol] \vec{C}ᵢ^{†}\vec{C}ⱼ [symbol] _{η}. Then we use the fact that the Hamiltonian of a Gaussian Fermionic system can be written in the eigenbasis of the correlation matrix as

$${H}_{η} = \frac{1}{2} {W}_{η} {σ}^{- 1} ( {Λ}_{η} ) {W}_{η}^{†} , \qquad ( D14 )$$

where W_{η} and Λ_{η} is given by the eigen decomposition Γ_{η}=W_{η}Λ_{η}W_{η}^{†}, and σ⁻¹(X) the inverse sigmoid function. Thus, we (numerically) diagonalize Γ_{η} and set the optimal Gaussian Fermionic QBM Hamiltonian equal to

$${H}_{{θ}^{*}} = \frac{1}{2} {W}_{η} {σ}^{- 1} ( {Λ}_{η} ) {W}_{η}^{†} .$$

Since the eigen decomposition of a Hermitian matrix is unique, we find one unique solution. This is in agreement with the strict convexity of the quantum relative entropy.
2c. Geometrically-Local Quantum Boltmann Machine

The last type of restricted QBM model we discuss are the geometrically-local QBMs. We consider the same Hamiltonian as for a generic fully connected 2-local QBM [Equation (16)], but then with additional constraints on the locality of the Pauli operators. In particular, we focus on nearest-neighbor models on some d-dimensional lattice, e.g. a one-dimensional chain where each Pauli operator only acts on two neighbouring qubits. In full generality, the parameterized QBM Hamiltonian is given by

$${ℋ}_{θ} = {\sum }_{k = x , y , z} {\sum }_{〈 i , j 〉} {λ}_{ij}^{k} {σ}_{i}^{k} {σ}_{j}^{k} + {\sum }_{i}^{n} {γ}_{i}^{k} {σ}_{i}^{k} , \qquad ( D15 )$$

where we sum over the nearest-neighbour sites [symbol] i,j [symbol] of the lattice with periodic boundary conditions. In the main text we consider for example a d=1 lattice (a ring), and a d=2 square lattice.

In order to use these models for pre-training, we train them with SGD on the relative entropy until a fixed precision is reached. Importantly, as these Hamiltonians only have m= [symbol] (n) terms and a finite interaction range, Anshu and Haah show that the quantum relative entropy is strongly convex. Therefore, the optimization is guaranteed to converge quickly to the global optimum, recall Theorem 2. However, this includes obtaining Gibbs state expectation values of geometrically local Hamiltonians. This can be done with a quantum computer, or potentially classically with tensor networks; see Kuwahara et al., “Improved thermal area law and quasilinear time algorithm for quantum Gibbs states”, Phys. Rev. X 11, 011047 (2021) and Alhambra et al., “Locally accurate tensor networks for thermal states and time evolution”, PRX Quantum 2, 040331 (2021).

### Appendix E: Construction of the Target State Expectation Values

In this appendix we review how to embed classical data into a target density matrix η. We will follow the approach for quantum spin models in Kappen, “Learning quantum models from quantum or classical data”, Journal of Physics A: Mathematical and Theoretical 53, 214001 (2020) (hereinafter “Kappen”). We also show how to extend this formalism to Fermionic quantum models needed for the pre-training of our Gaussian Fermionic QBM. Lastly, we describe the two different targets used for the numerical simulations in the main text.

### 1. Classical Data Encoding

Following the approach in Kappen, one way to encode a classical dataset consisting of N bit strings { [symbol] ∈{0,1}ⁿ}_{μ=1}^{M} into a quantum state is by defining the pure state

$$η = \vert ψ ψ \vert , \qquad ( E1 )$$

with

$$\vert ψ 〉 = {\sum }_{\vec{s} ∈ {\{ 0 , 1 \}}^{n}} \sqrt{q ( \vec{s} )} \vert \vec{s} 〉 . \qquad ( E2 )$$

Here

$$q ( \vec{s} ) = \frac{1}{N} {\sum }_{μ = 1}^{M} {δ}_{\vec{s} , {\vec{s}}^{μ}}$$

is the classical empirical probability for bitstring \vec{s}, and |\vec{s} [symbol] is a computational basis state indexed by \vec{s}. The q(\vec{s}) can be found by counting the bitstrings in the data set { [symbol] }. From |ψ [symbol] one can compute expectation values such as

$$〈 ψ \vert {σ}_{i}^{z} \vert ψ 〉 = {\sum }_{\vec{s} ∈ {\{ 0 , 1 \}}^{n}} q ( \vec{s} ) {\vec{s}}_{i} \qquad ( E3 )$$

for the Pauli spin operator σᵢ^{z}. This can be efficiently computed classically for a polynomially sized dataset, i.e. for polynomially many [symbol] . Computing such expectation values from η is possible for all 1- and 2-local Pauli operators as shown in Kappen.

We now show that we can generalize this encoding to Fermionic QBMs, i.e. the terms in the Hamiltonian ansatz consists of Fermionic creation cᵢ^{†} and annihilation operators cᵢ. We define |\vec{s} [symbol] to be equal to the Fermionic Fock basis. This is analogous to the computational basis in the spin-picture (by the Jordan-Wigner transformation), but the bit-strings { [symbol] ∈{0,1}ⁿ}_{μ=1}^{M} in the data set should now be interpreted as occupation-number vectors of Fermions. Note that the occupation number basis is defined by the eigenstates of the Fermionic number operator Σᵢcᵢ^{†}cᵢ.

The creation and annihilation operators act on the Fock-basis states as follows

$${c}_{i}^{†} \vert \vec{s} = ( 1 - {\vec{s}}_{i} ) \vert \vec{s} + , \qquad ( E4 )$$

$${c}_{i} \vert \vec{s} = {\vec{s}}_{i} \vert \vec{s} - ,$$

where [symbol] is the unit bit-string with a 1 at position i and zeros everywhere else. With these relations we can derive the required expectation values for the target η to train the (Gaussian) Fermionic QBM

$$ψ \vert {c}_{i}^{†} {c}_{i} \vert ψ = {\sum }_{\vec{s} ∈ {\{ 0 , 1 \}}^{n}} q ( \vec{s} ) {\vec{s}}_{i} , \qquad ( E5 )$$

$$ψ \vert {c}_{i}^{†} {c}_{j} \vert ψ = {\sum }_{\vec{s} ∈ {\{ 0 , 1 \}}^{n}} \sqrt{q ( \vec{s} ) q ( {F}_{i} {F}_{j} \vec{s} )} ( 1 - {\vec{s}}_{i} ) {\vec{s}}_{j} ,$$

$$ψ \vert {c}_{i}^{†} {c}_{j}^{†} \vert ψ = {\sum }_{\vec{s} ∈ {\{ 0 , 1 \}}^{n}} \sqrt{q ( \vec{s} ) q ( {F}_{i} {F}_{j} \vec{s} )} ( 1 - {\vec{s}}_{i} ) ( 1 - {\vec{s}}_{j} ) , i \neq j$$

$$ψ \vert {c}_{i} {c}_{j} \vert ψ = {\sum }_{\vec{s} ∈ {\{ 0 , 1 \}}^{n}} \sqrt{q ( \vec{s} ) q ( {F}_{i} {F}_{j} \vec{s} )} {\vec{s}}_{i} {\vec{s}}_{j} , i \neq j$$

$$ψ \vert {c}_{i} \vert ψ = {\sum }_{\vec{s} ∈ {\{ 0 , 1 \}}^{n}} \sqrt{q ( \vec{s} ) q ( {F}_{i} \vec{s} )} {\vec{s}}_{i}$$

$$ψ \vert {c}_{i}^{†} \vert ψ = {\sum }_{\vec{s} ∈ {\{ 0 , 1 \}}^{n}} \sqrt{q ( \vec{s} ) q ( {F}_{i} \vec{s} )} ( 1 - {\vec{s}}_{i} ) ,$$

where Fᵢ flips the Fermion occupation number (from occupied to unoccupied and vice versa) of index i in the vector \vec{s}.

### 2. Data Used for Numerical Simulations in the Main Text

For the numerical simulations in the main text we use two different targets η: 1) a target constructed from a quantum source, and 2) a classical data set embedded into η 1 using the encoding above. For the quantum source we use the XXZ model Hamiltonian

$${ℋ}_{XXZ} = {\sum }_{i = 1}^{n - 1} J ( {σ}_{i}^{x} {σ}_{i + 1}^{x} + {σ}_{i}^{y} {σ}_{i + 1}^{y} ) + Δ {σ}_{i}^{z} {σ}_{i + 1}^{z} + {\sum }_{i = 1}^{n} {h}_{z} {σ}_{i}^{z} . \qquad ( E6 )$$

Here J and Δ are the model parameters describing the Heisenberg interactions between the quantum spins on a one-dimensional lattice, and h_{z} the strength of an external magnetic field. We set

$$η = \frac{{e}^{H} xxz}{Z}$$

with J=−0.5, Δ=−0.7 and h_{z}=−0.8, and compute the expectation values [symbol] Hᵢ [symbol] _{η} classically. This is intractable in general, but our aim is to replicate the scenario in which the expectation values are measured experimentally—for example, from a state prepared on a quantum device.

For the classical source, we use the classical salamander retina dataset given in Tkačik et al., “Searching for collective behavior in a large network of sensory neurons”, PLOS Computational Biology 10, 1 (2014). This data set consists of bit-string data of different features of the response of cells in salamander retina. We select the first 8 features and trim the data to the first 10 data recordings. We then construct the expectation values [symbol] H [symbol] , from the procedure outlined above.

What is claimed is:

1. A method for performing machine learning using quantum computing hardware, the method comprising:
providing a model comprising a Quantum Boltzmann machine (QBM) with a Hamiltonian ansatz having a set of operators and a set of parameters;
performing a first stage of training the model against data from a target using a selected subset of the set of operators to obtain optimized values for a subset of the set of parameters, wherein the first stage of training is performed on classical binary computing hardware to provide a partly trained model; and
performing a second stage of training the model against data from the target using a larger subset of the set of operators to obtain optimized values for a larger subset of the set of parameters for the model, wherein the second stage of training is performed using quantum computer hardware, and wherein the optimized values from the first stage of training are used to initialize corresponding parameters for the second stage of training.

2. The method of claim 1, including iterating the second stage of training with a larger subset of operators and/or a larger subset of parameters in each iteration, to provide a trained Quantum Boltzmann machine in which a difference in expectation values between a target and the model is iteratively reduced.

3. The method of claim 1, wherein the first stage of training trains the model using quantum relative entropy between the model and the target.

4. The method of claim 3, wherein gradients of the quantum relative entropy are determined with respect to expectation values for the model and the target.

5. The method of claim 1, wherein the first stage of training is performed using a mean-field (MF) model, a one-dimensional or two-dimensional geometrically local (GL) model, and/or a Gaussian Fermionic (GF) model.

6. The method of claim 1, wherein parameters which are not in the selected subset of the operators are maintained at zero during the first stage of training.

7. The method of claim 1, wherein the selected subsets of operators and parameters use substantially all computational resources from the classical binary computer hardware.

8. The method of claim 1, further comprising extending the Hamiltonian ansatz from the subsets of operators and parameters of the first stage to the subsets of the operators and parameters of the second stage.

9. The method of claim 1, wherein the second stage of training is performed on the quantum computing hardware with respect to all the parameters.

10. The method of claim 1, wherein the second stage of training includes optimizing quantum relative entropy with respect to all the parameters by computing Gibbs expectation values on the quantum computing hardware.

11. The method of claim 10, wherein the first stage of training comprises training the model using quantum relative entropy between the model and the target to provide the partly trained model comprising a Quantum Boltzmann Machine, and wherein the second stage of training comprises sampling the partly trained model by preparation of Gibbs states and the computing of Gibbs expectation values, wherein each sampling of the model comprises preparation of a Gibbs state and computation of Gibbs expectation values on the quantum computing hardware.

12. The method of claim 1, wherein the second stage of training includes performing a stochastic gradient descent.

13. The method of claim 1, wherein the second stage of training involves T iterations each involving N samples, wherein N×T scales polynomially with a number of terms in the QBM Hamiltonian.

14. The method of claim 1, further comprising extending, for a third stage of training, the Hamiltonian ansatz with at least one other set of operators and parameters, wherein the at least one other set of operators and parameters are optionally orthogonal.

15. The method of claim 14, further comprising initializing the parameters of the QBM with an extended Hamiltonian ansatz using optimal parameters from a previous quantum optimization loop.

16. The method of claim 1, wherein Gibbs states are used to provide samples for machine learning.

17. The method of claim 1, wherein Gibbs states used for the Quantum Boltzmann machine are prepared and sampled on the quantum computing hardware and the parameters are maintained on the classical binary computing hardware.

18. A machine learning system comprising:
a first portion comprising classical binary computing hardware configured to provide a partly trained model with respect to a target, wherein the model comprises a Quantum Boltzmann machine with a Hamiltonian ansatz having a set of operators and a set of parameters, and wherein the classical binary computing hardware is configured to use a selected subset of the set of operators to obtain optimized values for a subset of the set of parameters; and
a second portion comprising quantum computing hardware configured to provide, at least partly, a trained model with respect to the target, wherein the second portion is configured to use a subset of the set of operators larger than the first portion used to obtain optimized values for a subset of the set parameters larger than the first portion obtained, and wherein the optimized values from the first portion are used to initialize corresponding parameters for use by the second portion.

19. A system according to claim 18, wherein the quantum computing hardware is implemented using a plurality of qubits which can each be programmatically connected to any other qubit of the plurality.

20. A machine learning system comprising quantum computing hardware configured to:
provide a Quantum Boltzmann machine with a Hamiltonian ansatz having a set of operators and a set of parameters;
receive, from a classical binary computing system, optimized parameter values for a selected subset of the set of parameters associated with a selected subset of the operators of the Quantum Boltzmann machine;
use the received optimized parameter values from the classical binary computing system to initialize corresponding parameters of the Quantum Boltzmann machine; and
train the Quantum Boltzmann machine with a larger subset of the operators of the Hamiltonian ansatz to optimize parameter values of the Quantum Boltzmann machine for machine learning.
